(19) United States
(12) Patent Application Publication
(10) Pub. No.: US 2012/0166744 A1
(43) Pub. Date: Jun. 28, 2012

(54) MEMORY MANAGEMENT METHOD, COMPUTER SYSTEM, AND STORAGE MEDIUM HAVING PROGRAM STORED THEREON

(75) Inventors: Ryozo Yamashita, Yokohama (JP); Hiroyasu Nishiyama, Kawasaki (JP); Tomoya Ohta, Sagamihara (JP)

(73) Assignee: Hitachi, Ltd.

(21) Appl. No.: 13/322,067

(22) PCT Filed: May 19, 2010
(86) PCT No.: PCT/JP2010/058853

§ 371 Date: Feb. 7, 2012

(30) Foreign Application Priority Data
May 25, 2009 (JP) 2009-125274

(51) Int. Cl. G06F 12/00

(52) U.S. Cl. 711/159; 711/E12.103

(57) ABSTRACT

A memory management method, which is used in a computer including a CPU and a memory to unload an area no longer necessary out of a memory area used by a program stored in the memory and executed by the CPU, comprising: generating a first processing system for executing the program in the memory; generating a second processing system in the memory when a first opportunity occurs; copying a content of a memory area of the first processing system to a memory area of the second processing system; determining an unnecessary area out of the copied memory area of the second processing system; transmitting a determination result regarding the unnecessary area to the program of the first processing system when a second opportunity occurs receiving the determination result; unloading the unnecessary area in the memory area of the first processing system.

### BACKGROUND OF THE INVENTION

This invention relates to a memory management method, a computer system, and a storage medium having a program stored thereon, and more particularly, to a memory management method, a computer system, and a storage medium having a program stored thereon which relate to garbage collection processing.

Garbage collection (hereinafter, referred to as GC) exists as implicit collection means for objects assigned on a memory used by a program in a computer system. The GC determines presence/absence of possibility that each of objects on the memory is to be used by a program, and collects objects the possibility of use of which is none (hereinafter, referred to as garbage objects). The GC is used by the Java virtual machine (Java VM) and the like.

Basic processing of the GC routes a reference relationship of objects on the memory from sources from which a program can route references (hereinafter, referred to as reference root), determines an object for which a goal is not reached as a garbage object, and collects the determined objects as the garbage objects.

There are the stop-the-world method and the concurrent method as general methods of the GC. In the stop-the-world method, processing execution of a program is stopped when the GC starts, the determination processing and the collection processing are carried out in a state in which a reference relationship of objects on the memory are not changed, and the processing by the program is resumed after the collection processing. The concurrent method carries out the determination processing and the collection processing in parallel with the processing execution of the program, and hence the processing by the program hardly stops (see Non Patent Literature 1).

Moreover, the memory area is managed as fixed length areas (pages) in many computer systems. It is known that very efficient garbage object collection processing can be carried out by setting only garbage objects in a memory page containing only garbage objects (hereinafter, referred to as garbage page) to be collected during the garbage object collection processing, and omitting collection of garbage objects in a memory page containing non-garbage objects (see Non Patent Literature 2).

Moreover, in recent years, a configuration which uses a software program called hypervisor, and controls a plurality of virtual computer systems to operate on one computer system has become popular. In this configuration, the hypervisor provides a function (live migration function) of migrating a virtual computer system among a plurality of hypervisors while the execution of programs on the virtual computer systems are hardly stopped (see Non Patent Literature 3).

The live migration is carried out by copying the entire virtual computer system including contents of a memory being used to another hyper visor. It should be noted that operating systems conventionally used in general also provide a function of generating a copy of a running program (see Non Patent Literature 4).

### CITATION LIST

Non Patent Literature 1 Garbage Collection: Algorithms for Automatic Dynamic Memory Management (Richard Jones, Rafael Lins, 1996, John Wiley & Sons Inc, ISBN: 978-0471941484), p183

Non Patent Literature 2 Michal Wegiel and Chandra Krintz, The Mapping Collector: Virtual Memory Support for Generational, Parallel, and Concurrent Compaction, ACM SIGOPS Operating Systems Review Vol. 42 Issue 2, 2008, p.91-102

Non Patent Literature 3 Christopher Clark, Keir Fraser, Steven H, Jacob Gorm Hansen, Eric Jul, Christian Limpach, Ian Pratt, and Andrew Warfield, Live Migration of Virtual Machines, 2nd ACM/USENIX Symposium on Networked Systems Design and Implementation, 2005, p.273-286

Non Patent Literature 4 Operating System, Third edition (Andrew S. Tanenbaum, 2007, Pearson Education, ISBN: 978-4894717695), p29

### SUMMARY

According to the GC of the stop-the-world method, processing by a program stops during the processing by the CG, which poses a problem of response. According to the stop-the-world method, if the quantity of memory handled by a computer system increases as opportunities of operation in a large environment increase and the semiconductor technology develops, the stop period caused by the GC processing also extends. A response time of business applications is thus seriously influenced.

According to the GC of the concurrent method, processing of recording reference relationships among objects on the memory changed by execution of a program during the processing for the GC, and investigating changed portions again is necessary. This processing is carried out for preventing a case where an object possibly used by the program (non-garbage object) is determined by mistake as a garbage object, and is collected. As a result, in the concurrent method, it is necessary for the program to carry out recording processing, which is not necessary for carrying out original processing, each time the program changes a reference relationship among objects on the memory, and the throughput (performance upon running) remarkably decreases compared with the stop-the-world method.

An object of this invention is to enable GC processing simultaneously realizing a high throughput and a short stop period.

A representative aspect of this invention is as follows. A memory management method, which is used in a computer including a calculation device and a memory to unload an area no longer necessary out of a memory area used by a program stored in the memory and executed by the calculation device, comprising: generating, by the calculation device, a first processing system for executing the program in the memory; generating, by the calculation device, a second processing system in the memory when a first opportunity occurs; copying, by the calculation device, a content of a memory area of the first processing system to a memory area of the second processing system; determining, by the calculation device, an unnecessary area out of the copied memory area of the second processing system; transmitting, by the calculation device, a determination result regarding the unnecessary area to the program of the first processing system when a second opportunity occurs; receiving, by the calculation device, the determination result in the first processing system; and unloading, by the calculation device, the unnecessary area in the memory area of the first processing system based on the determination result regarding the unnecessary area received in the first processing system.

According to embodiments of this invention, the GC processing simultaneously realizing a high throughput and a short stop period can be provided by carrying out a part of the GC processing in another processing system.

### BRIEF DESCRIPTION OF THE DRAWINGS

### First Embodiment

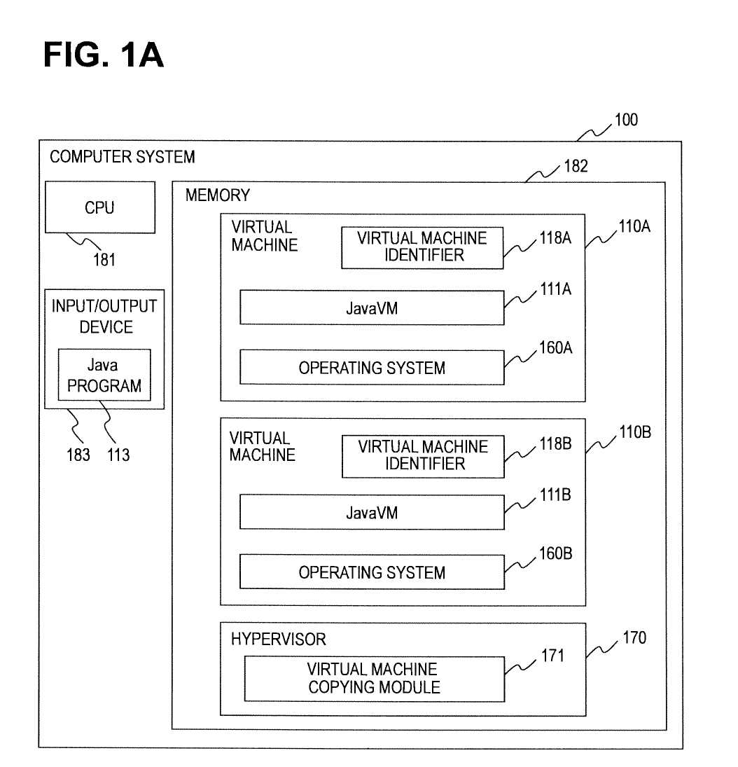

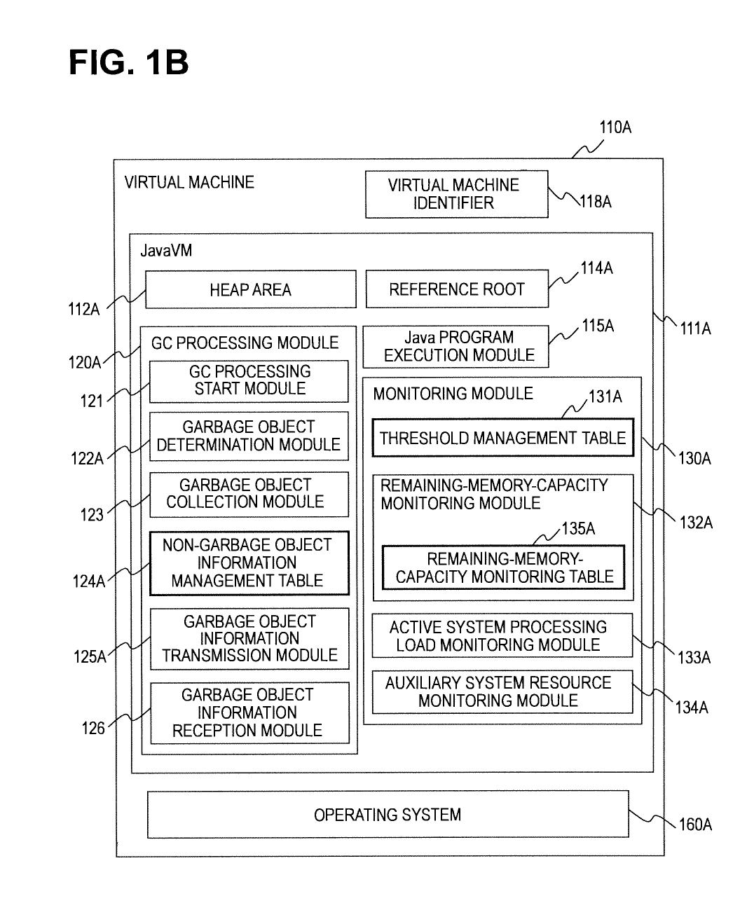

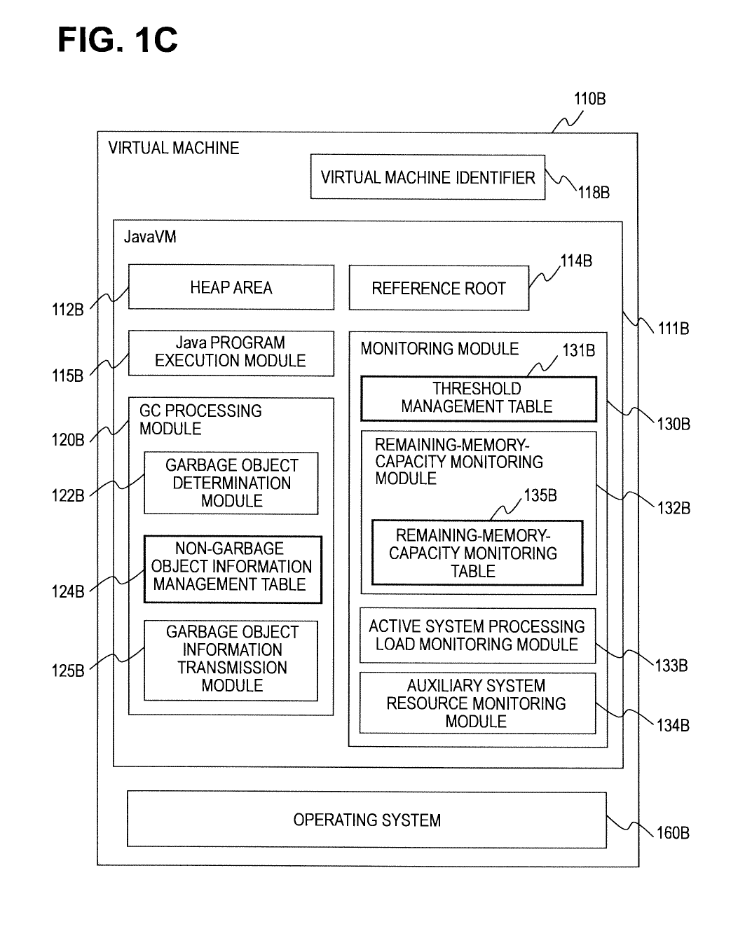

FIGS. 1A to 1C show first embodiment of this invention, and are block diagrams showing an example of a computer system.

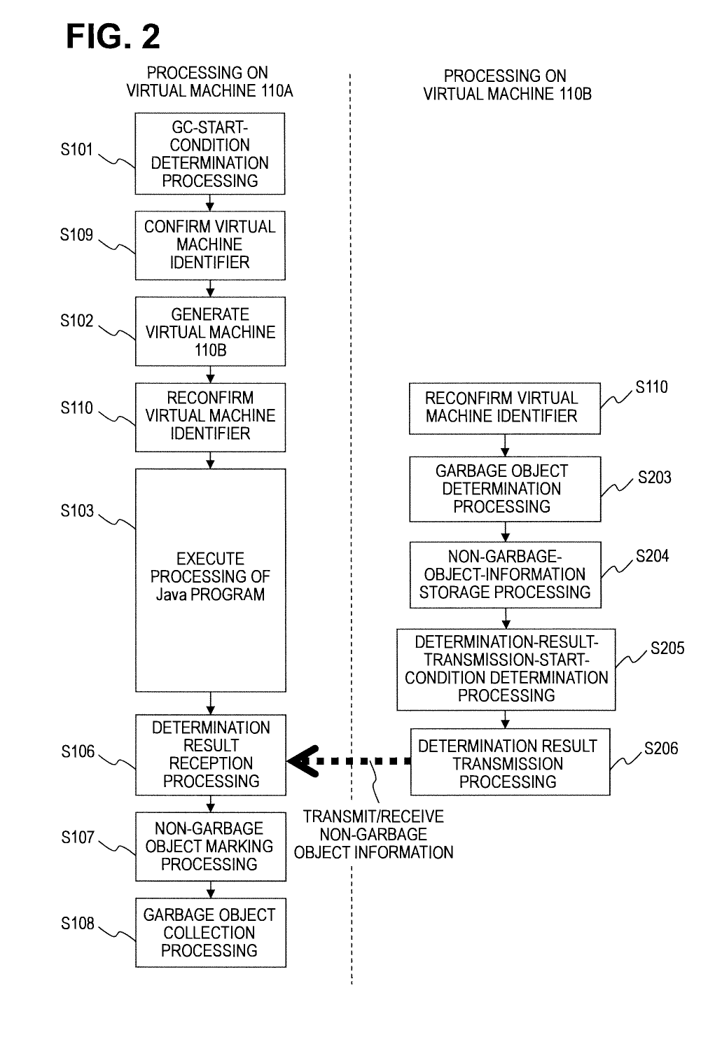

FIG. 2 shows a first embodiment of this invention, and is a sequence diagram illustrating an overview of the GC processing.

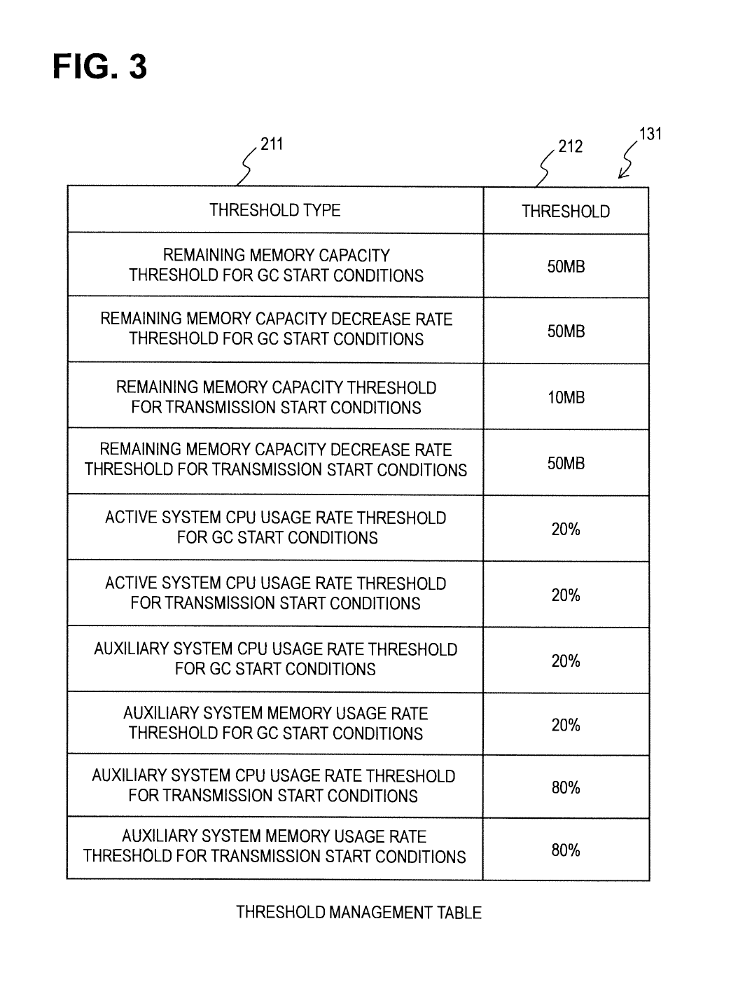

FIG. 3 shows a first embodiment of this invention, and is a diagram illustrating an example of a data format of the threshold management table.

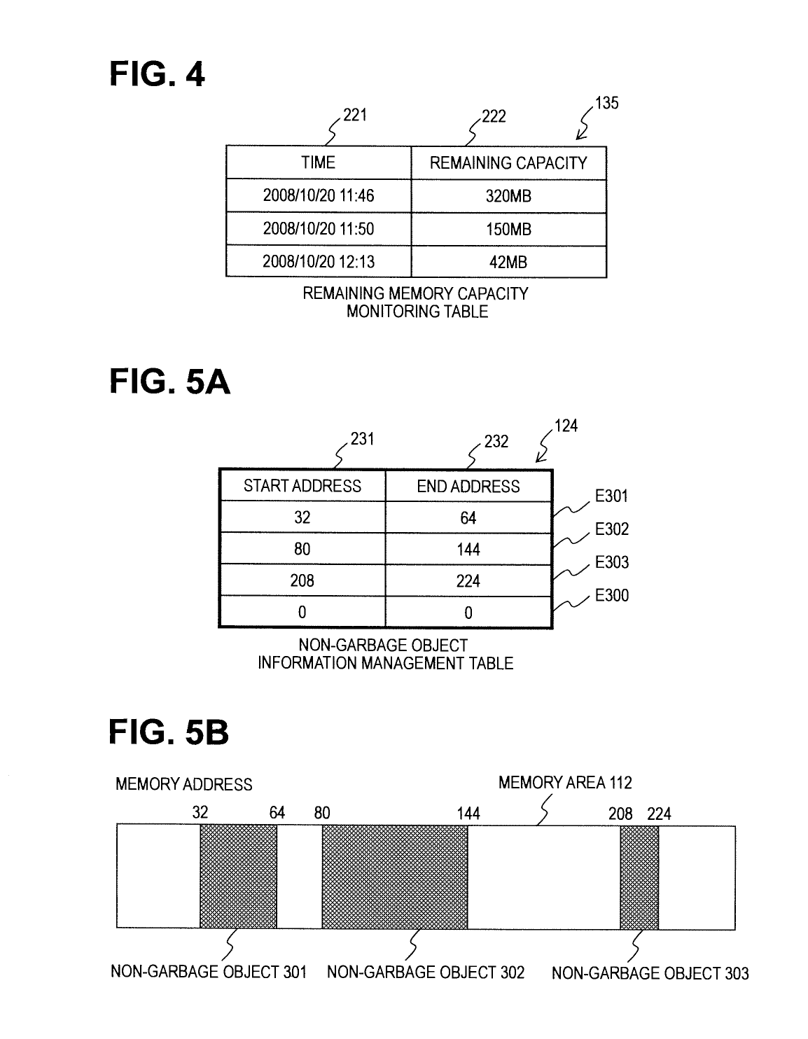

FIG. 4 shows a first embodiment of this invention, and is a diagram illustrating an example of a data format of the remaining memory capacity management tables

FIG. 5A shows a first embodiment of this invention, and is diagram illustrating an example of a data format of the non-garbage object information management table.

FIG. 5B shows a first embodiment of this invention, and is a memory map illustrating an example in which the non-garbage object information management table 124 is applied to the heap area 112.

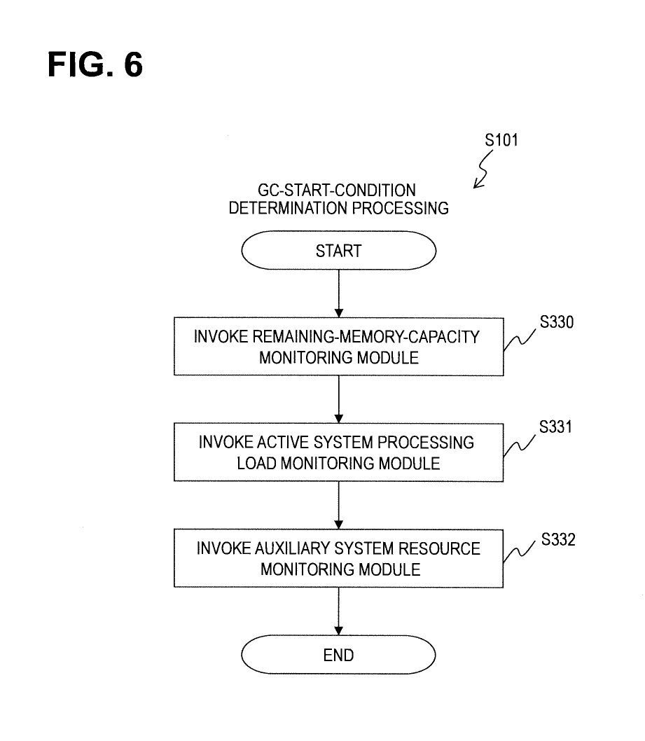

FIG. 6 shows a first embodiment of this invention, and is a flowchart illustrating an example in which the GC-start-condition determination processing.

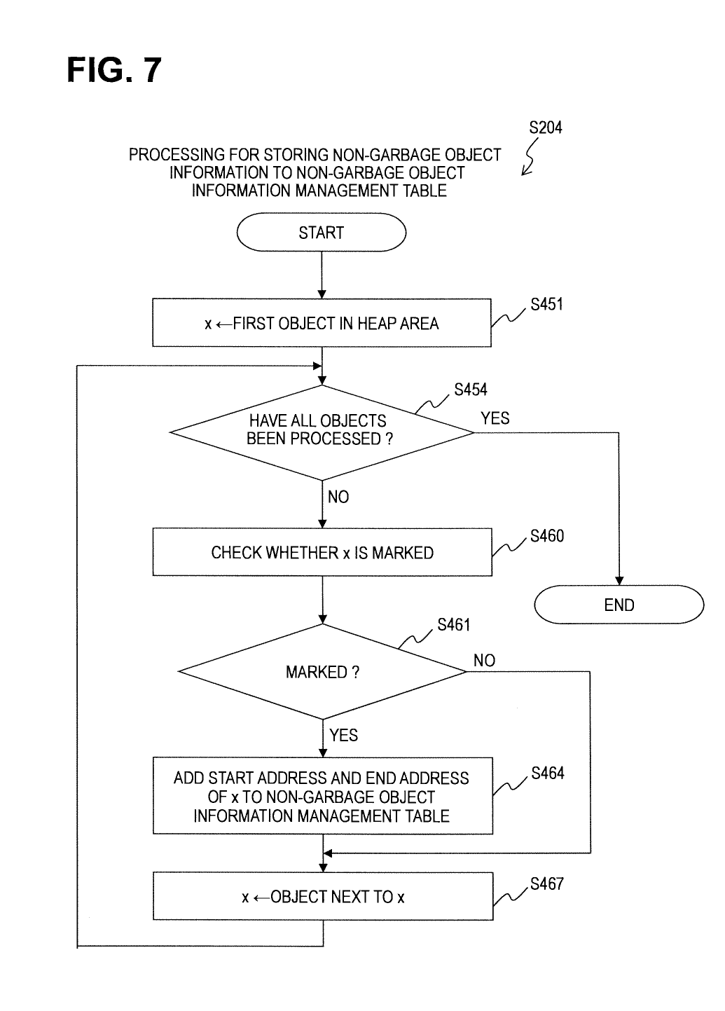

FIG. 7 shows a first embodiment of this invention, and is a flowchart illustrating an example in which the processing for storing non-garbage object information to non-garbage object information management table.

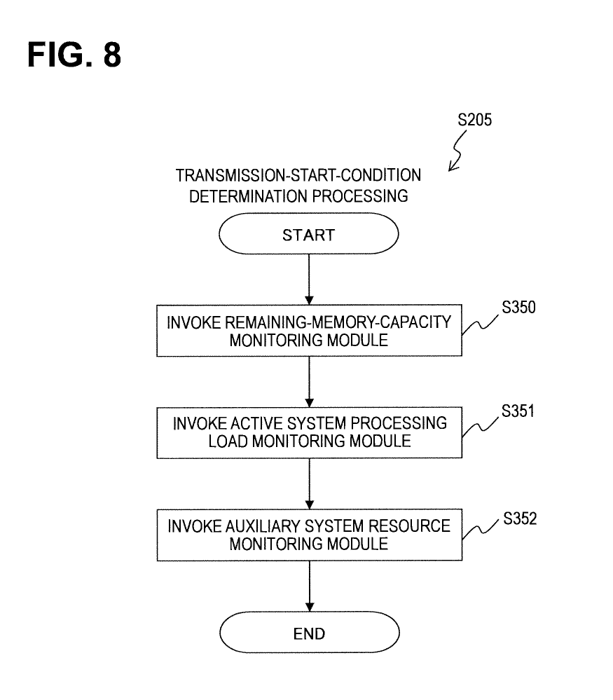

FIG. 8 shows a first embodiment of this invention, and is a flowchart illustrating an example in which the transmission-start-condition determination processing

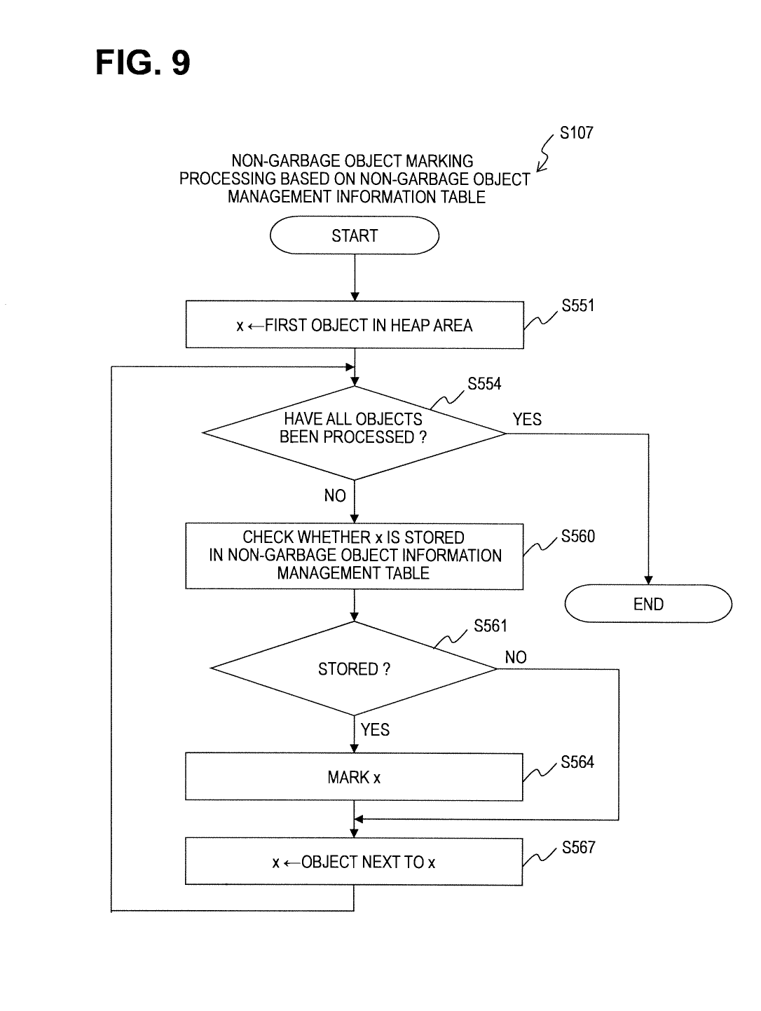

FIG. 9 shows a first embodiment of this invention, and is a flowchart illustrating an example in which the non-garbage object marking processing.

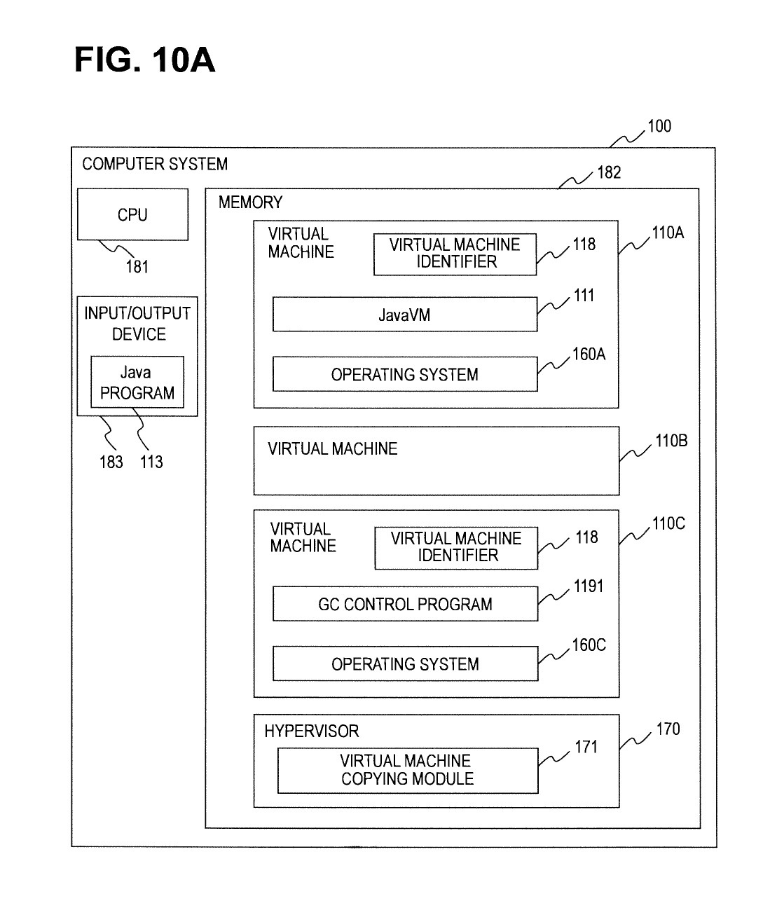

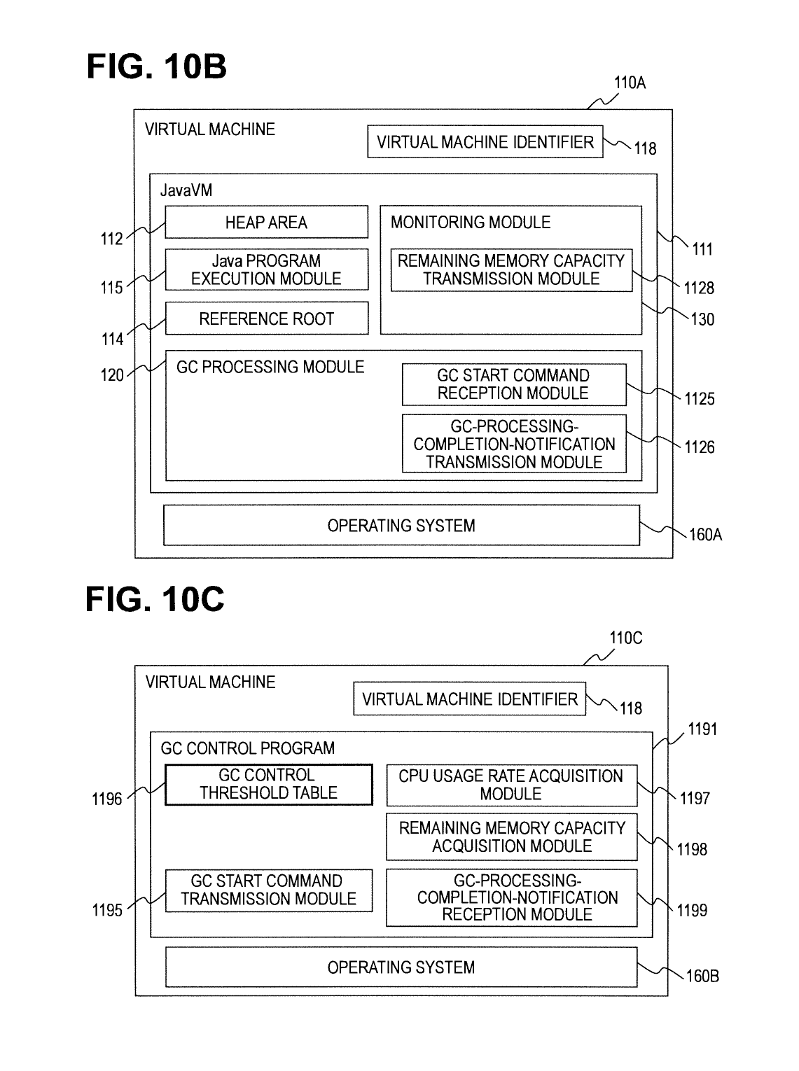

FIGS. 10A to 10C show second embodiment of this invention, and are block diagrams showing an example of a computer system.

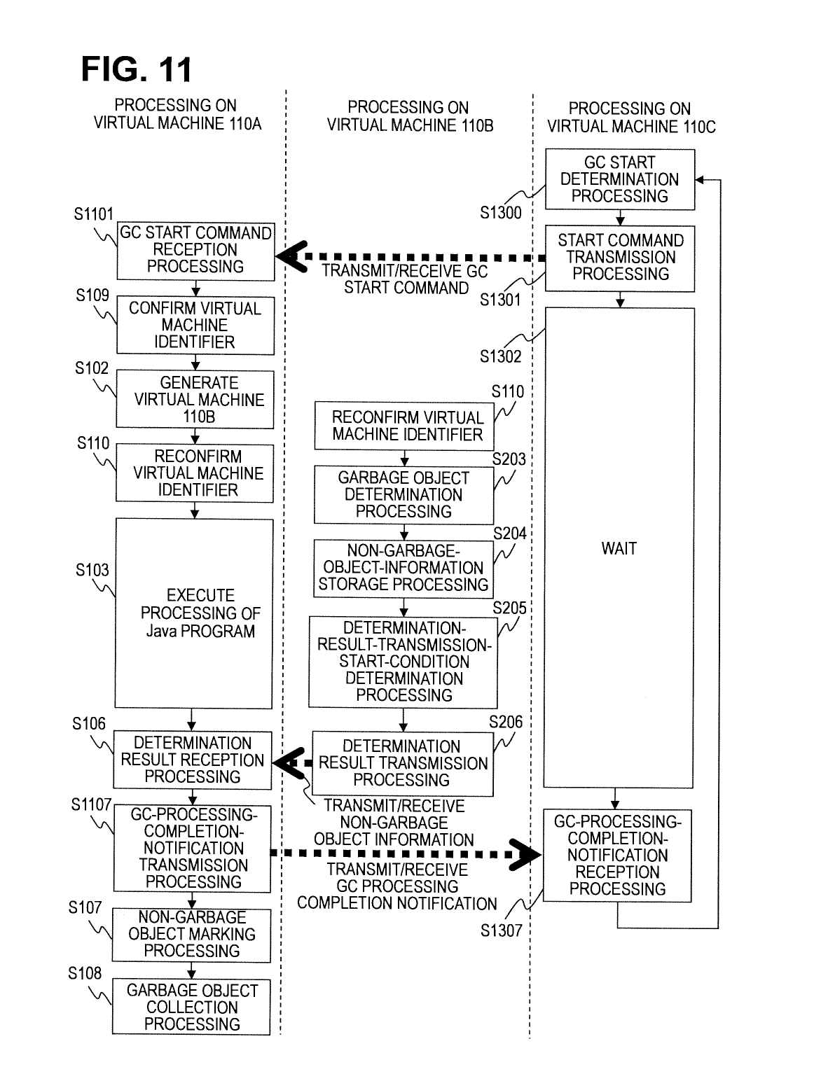

FIG. 11 shows a second embodiment of this invention, and is a sequence diagram illustrating an overview of the GC processing.

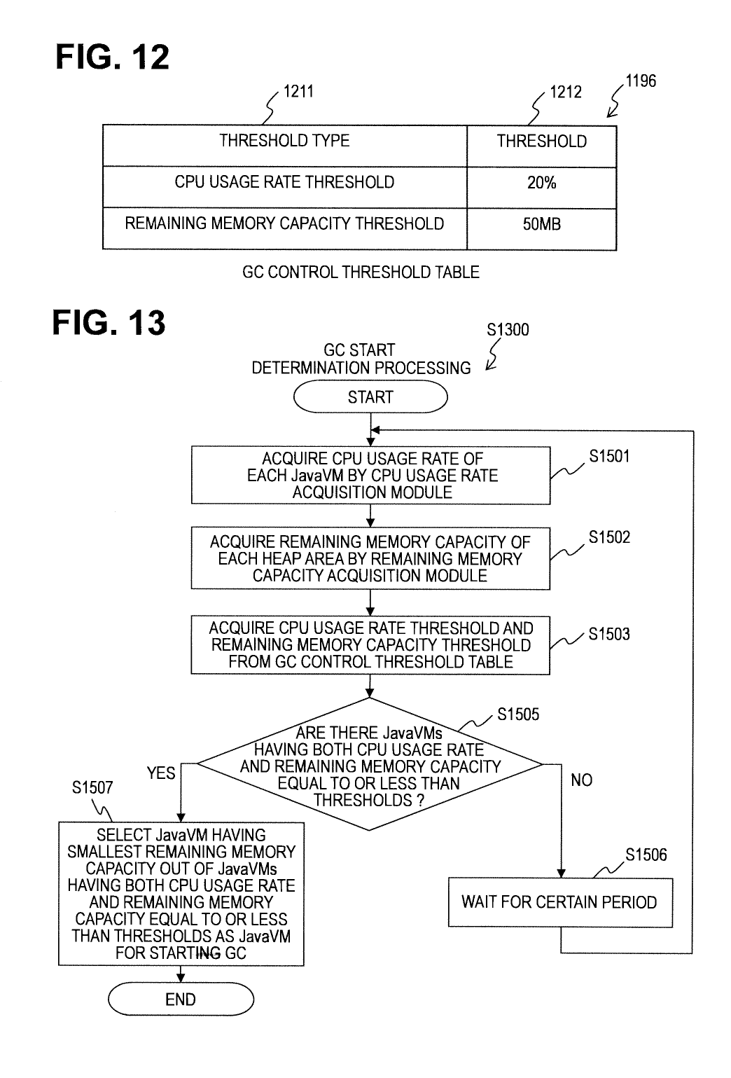

FIG. 12 shows a second embodiment of this invention, and is a diagram illustrating a diagram illustrating an example of a data format of the GC control threshold table.

FIG. 13 shows a second embodiment of this invention, and is a flowchart illustrating an example in which the GC start determination processing.

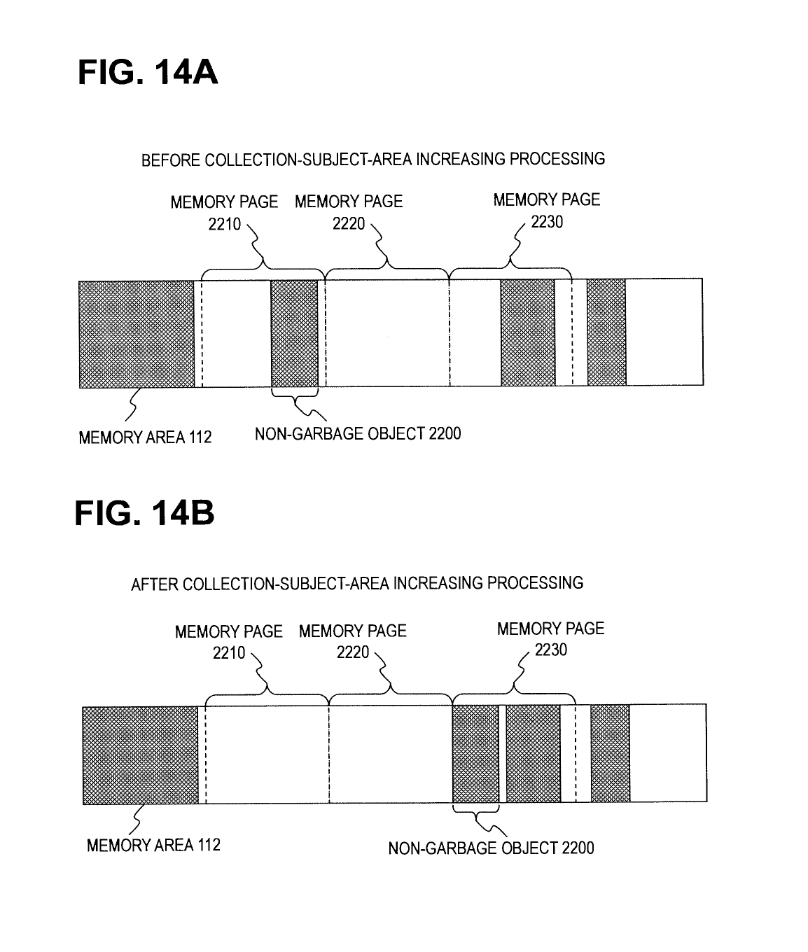

FIGS. 14A and 14B show a third embodiment of this invention, are explanatory diagrams illustrating an example of the effect of improving the memory usage efficiency by collection-subject-area increasing processing.

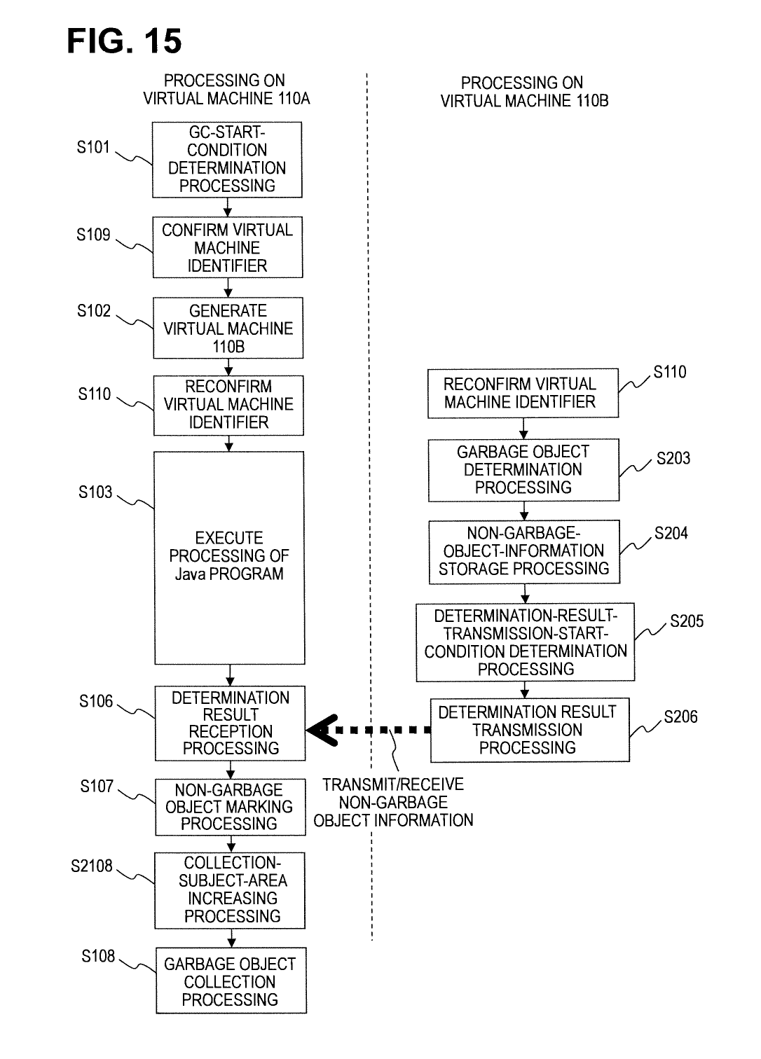

FIG. 15 shows a third embodiment of this invention is a sequence diagram illustrating an overview of the GC processing.

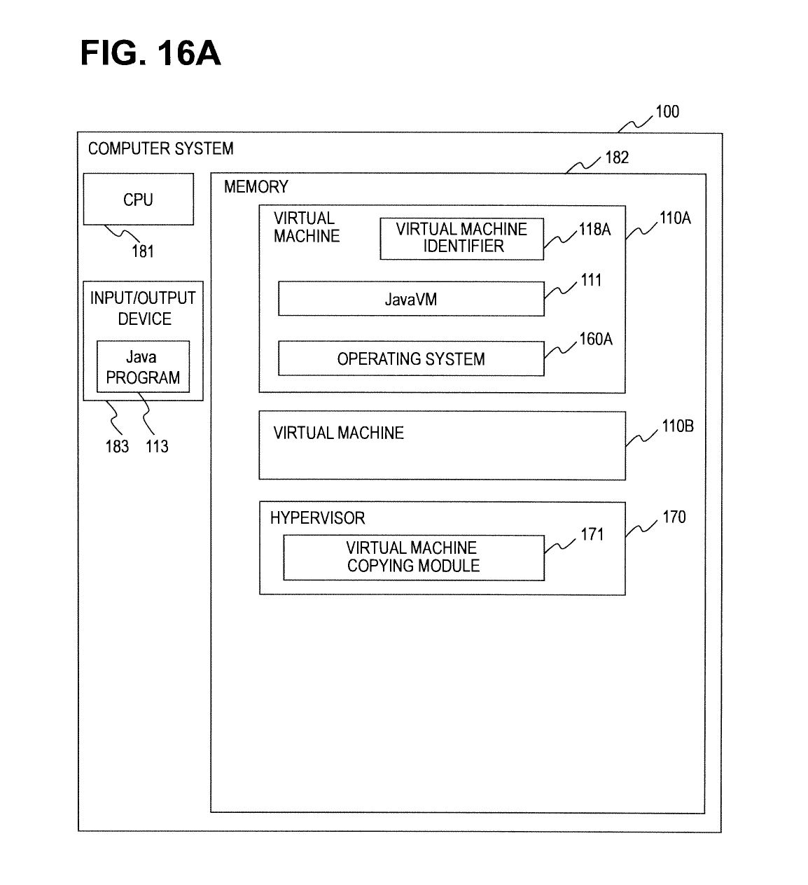

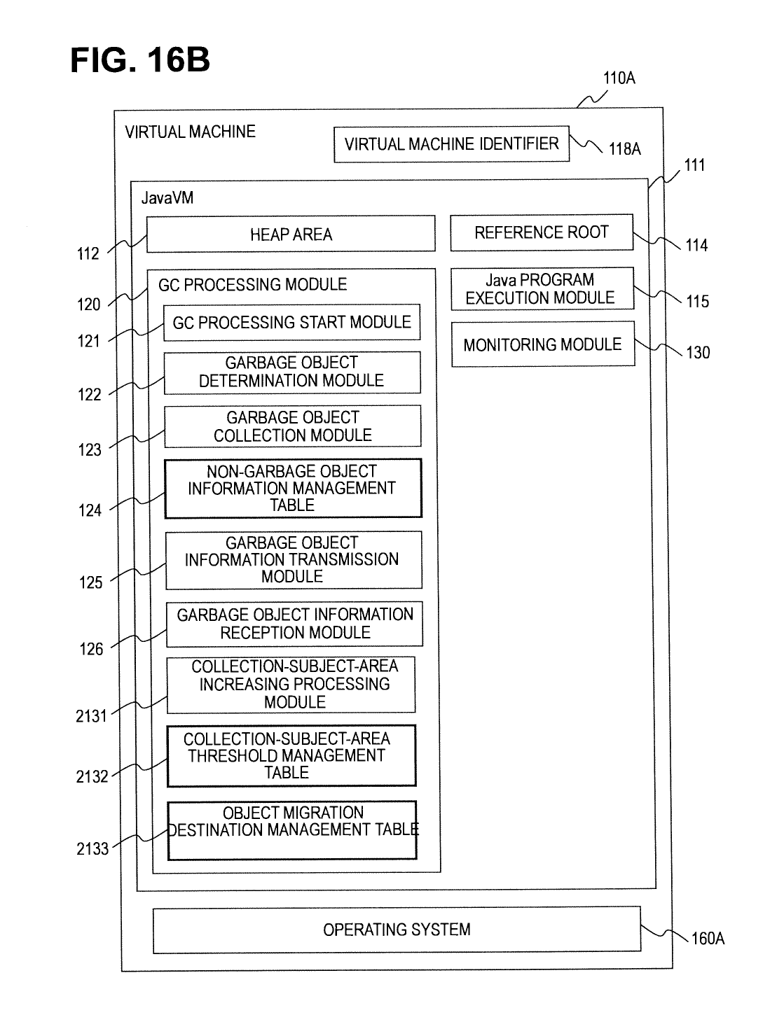

FIGS. 16A and 16B show a third embodiment of this invention, are block diagrams illustrating a configuration of the computer system.

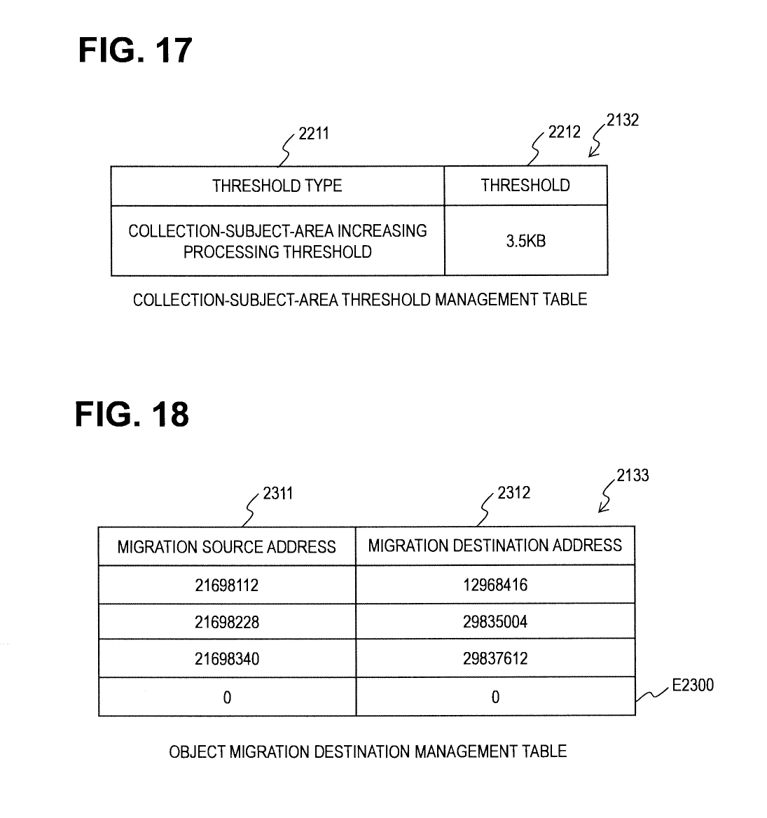

FIG. 17 shows a third embodiment of this invention is a diagram illustrating an example of a data format of the collection subject area threshold management table.

FIG. 18 shows a third embodiment of this invention is a diagram illustrating an example of a data format of the object migration destination management table.

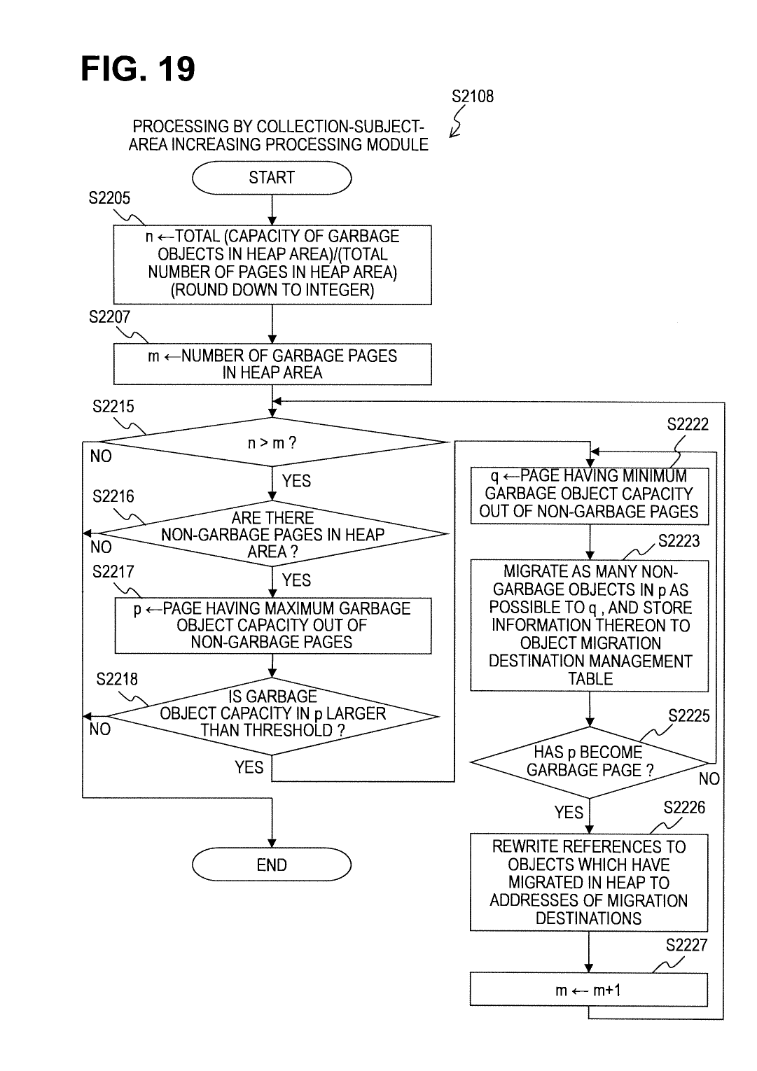

FIG. 19 shows a third embodiment of this invention is a flowchart illustrating an example of a processing by collection-subject-area increasing processing module.

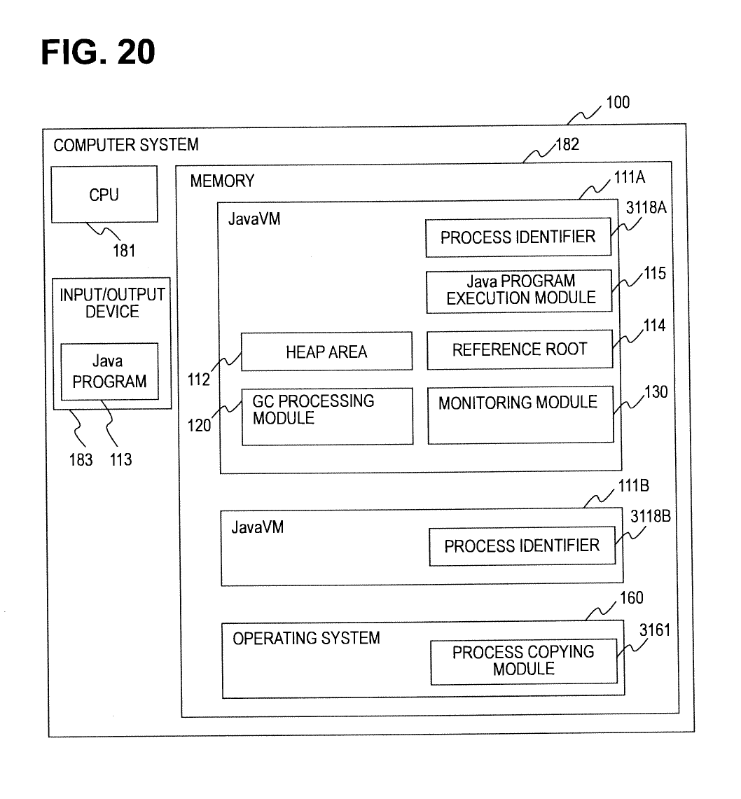

FIG. 20 shows a fourth embodiment of this invention is a configuration block diagram of the computer system.

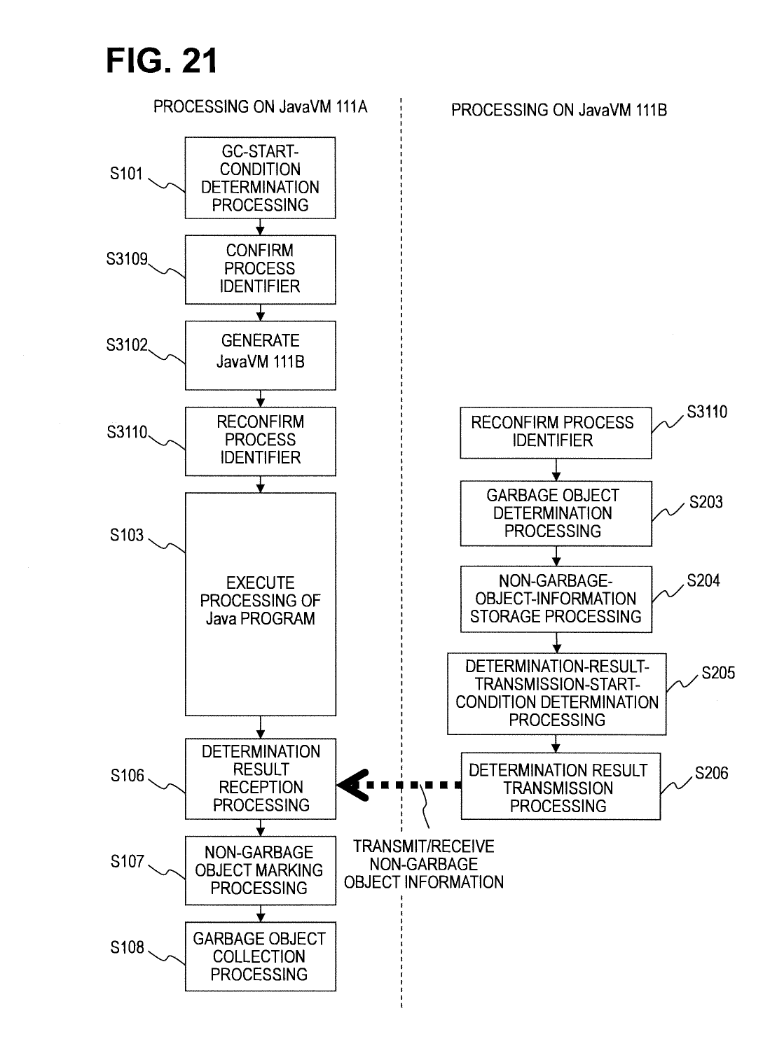

FIG. 21 shows a fourth embodiment of this invention is a sequence diagram illustrating an overview of the GC processing.

### DETAILED DESCRIPTION OF THE PREFERRED EMBODIMENTS

Hereinafter, a description is given of embodiments of this invention referring to drawings.

Referring to the drawings, a detailed description is now given of an embodiment for a case where JavaVMs 111 (111A and 111B) are used as programs running on a computer system 100, and GC processing for the JavaVMs 111 is started on a predetermined opportunity by monitoring inside the JavaVMs 111.

FIGS. 1A to 1C are block diagrams illustrating a configuration of a computer system according to a first embodiment. As illustrated in FIG. 1A, the computer system 100 according to this embodiment includes a CPU 181, a memory 182, and an input/output device 183. It should be noted that the computer system 100 is a physical computer system.

A hypervisor 170 is stored in the memory 182. Virtual machines 110 (110A and 110B) are constructed on the memory 182 by the CPU 181 executing the hypervisor 170. The hypervisor 170 controls assignment of the CPU 181, the memory 182, and the input/output device 183 to the virtual machines 110. The assignment is set by an administrator or the like in advance. The virtual machine 110 emulates a physical computer system using the assigned CPU 181, memory 182 and input/output device 183. Moreover, each of the virtual machines 110 has a unique virtual machine identifier 118 (118A and 118B) set by the hypervisor 170.

The hypervisor 170 includes a virtual machine copying module 171. The virtual machine copying module 171 is a processing module for generating a copy of the virtual machine 110 managed by the hyper visor 170. The copying processing is carried out by the virtual machine copying module 171 by omitting deletion of a virtual machine which is a source of the copying after a copy is generated by a live migration feature. After the copy of the virtual machine is generated, the virtual machine copying module 171 sets the virtual machine identifier 118 of the virtual machine which is the destination of the copying to a value different from the virtual machine identifier 118 of the virtual machine which is the source of the copying. The generated copy of the virtual machine contains exactly the same components as those of the virtual machine which is the source of copying except for the virtual machine identifier 118. Moreover, each of the copied components of the virtual machine starts operations in exactly the same state as those of a corresponding component of the source of copying when the copy is finished. It is possible to recognize the completion of the copying processing by the virtual machine copying module 171 by inquiring the virtual machine copying module 171 of a processing state regarding the copy-source virtual machine. It should be noted that the virtual machine copying module 171 may notify the completion of the processing by means of an interruption to the copy-source virtual machine or the like after the copying processing has been completed.

The virtual machine 110B is a virtual machine generated by the virtual machine copying module 171 copying the virtual machine 110A during the GC processing for the JavaVM 111A.

It should be noted that the number of the virtual machine 110A is not necessarily one, and a plurality of virtual machines 110A may exist on the memory 182.

An operating system 160A and the JavaVM 111A operate on the virtual machine 110A. The JavaVM 111A includes a heap area 112A, a reference root 114A, a Java program execution module 115A, a GC processing module 120A, and a monitoring module 130A. A Java program 113 read from the input/output device 183 is executed on the JavaVM 111A by the Java program execution module 115. The Java program execution module 115 assigns objects which become necessary during the execution of processing for the Java program 113 in the heap area 112A. Moreover, the Java program execution modules 115A and 115B store references to objects in the heap areas 112A and 112B in the reference roots 114 (114A and 114B), thereby manipulating the objects.

Moreover, an operating system 160B and the JavaVM 111B run on the virtual machine 110B. The JavaVM 111B includes the heap area 112B, the reference root 114B, the Java program execution module 115B, a GC processing module 120B, and a monitoring module 130B.

Moreover, the monitoring modules 130A and 130B of the virtual machine 110A and the virtual machine 110B are generally referred to as monitoring module 130, and other functional portions are also generally referred to as numerals without suffixes “A” or “B” in a similar manner. This invention is applied to the GC processing for unloading objects assigned in the heap area 112A by the Java program execution module 115. The GC processing by the virtual machine 110A is executed by the GC processing modules 120A and 120B and the monitoring modules 130A and 130B. The GC processing module 120A includes a GC processing start module 121, a garbage object determination module 122A, a garbage object collection module 123, a garbage object information transmission module 125A, a garbage object information reception module 126, and a non-garbage object info illation management table 124A. It should be noted that the non-garbage object information is information on objects being executed or to be executed (or to be used) by the Java program execution module 115 out of objects stored in the heap area 112. The garbage object is an object which is not to be executed or to be used, and can thus be removed from the heap area 112.

The GC processing module 120B of the virtual machine 110B includes a garbage object determination module 122B, a garbage object information transmission module 125B, and a non-garbage object information management table 124B. It should be noted that, though the GC processing start module 121, the garbage object collection module 123, and the garbage object information reception module 126 are also copied to the virtual machine 110B, which is a copy of the virtual machine 110A, each of the functions is stopped, and is thus not illustrated.

The GC processing start module 121 of the virtual machine 110A is a processing module for requesting the virtual machine copying module 171 of the hypervisor 170 for generating a copy of the virtual machine 110A, thereby starting the GC processing.

Each of the garbage object determination modules 122A and 122B is a processing module for marking non-garbage objects in the heap areas 112A and 112B. The garbage object collection module 123 is a processing module for collecting objects which are not marked in the heap area 112A.

The garbage object information transmission module 125B of the virtual machine 110B is a processing module for transmitting information on marked objects in the heap area 112B to the garbage object information reception module 126 of the virtual machine 110A. The garbage object information reception module 126 of the virtual machine 110A is a processing module for marking non-garbage objects in the heap area 112A based on the information on the non-garbage objects received from the garbage object information transmission module 125B of the virtual machine 110B. The non-garbage object information management tables 124A and 124B are tables for storing information on non-garbage objects, and are used in the transmission/reception processing and the marking processing by the garbage object information transmission module 125B and the garbage object information reception module 126. The monitoring modules 130A and 130B are processing modules for determining conditions for starting the GC processing and the non-garbage object information transmission processing, and notifying an opportunity for starting the processing.

FIG. 2 is a sequence diagram illustrating an overview of the GC processing according to the first embodiment.

First, in the computer system 100, the hypervisor 170 generates the virtual machine 110A in the memory 182 in response to an instruction provided by the administrator or a user, activates the OS 160A in the virtual machine 110A, and then executes the JavaVM 111A.

The GC processing is started if the GC processing start module 121A confirms the value of the virtual machine identifier 118A (S109) in a predetermined opportunity (S101), and requests the virtual machine copying module 171 of the hypervisor 170 for copying the virtual machine 110A (S102). The virtual machine copying module 171, which has received the request for generating a copy, generates the virtual machine 110B, which is a new copy of the virtual machine 110A. The opportunity for the start of the GC is determined by the monitoring module 130A (S101), and the GC processing start module 121A starts the GC if the monitoring module 130A has set a GC start flag.

The GC processing start module 121A periodically makes an inquiry to the virtual machine copying module 171, and waits until it is determined that the copying processing of the virtual machine 110A has been finished. The execution of the Java program 113 by the Java program execution module 115A continues during this period. The virtual machine 110A and the virtual machine 110B simultaneously operate after the virtual machine 110B is generated. The GC processing start module 121 first confirms again the virtual machine identifier 118 on each of the virtual machines 110 (S110). The virtual machine copying module 171 sets the virtual machine identifier 118B of the virtual machine 110B to a value different from the virtual machine identifier 118A of the virtual machine 110A. Therefore, each of the GC processing start modules 121 can identify the virtual machine 110 on which the each of the GC processing start modules 121 is operating by comparing the reconfirmed virtual machine identifier 118 to the value of the virtual machine identifier 118A confirmed in Step S109. The GC processing start modules 121A and 121B respectively carry out different processing based on this configuration.

The GC processing start module 121B stops the Java program execution module 115B, and activates the garbage object determination module 122B in the virtual machine 110B. The garbage object determination module 122B carries out garbage object determination processing on the heap area 112B (S203). Specifically, the garbage object determination module 122B carries out the garbage object determination processing by routing the reference relationship of objects in the heap area 112B starting from the reference root 114B, and marking the routed objects. This processing continues until all objects which can be routed from the reference root 114B are marked in the heap area 112B. After the garbage object determination processing is finished, in the virtual machine 110B, the garbage object information transmission module 125B stores the non-garbage object information in the non-garbage object information management table 124B based on the mark attached to each of the objects in the heap area 112B (S204).

The execution of the Java program 113 by the Java program execution module 115 continues in the virtual machine 110A during the garbage object determination processing by the virtual machine 110B (S103).

In the virtual machine 110B, the garbage object information transmission module 125B transmits, in a predetermined opportunity, the content of the non-garbage object information management table 124B to the virtual machine 110A after the processing of storing the non-garbage object information in the non-garbage object information management table 124B (S206).

In the virtual machine 110A, the garbage object information reception module 126 receives the content of the non-garbage object information management table 124B from the virtual machine 110B (S106), and marks non-garbage objects in the heap area 112A based on the determination result in the table (S107). The opportunity of the transmission in Step S206 is determined by the monitoring module 130B (S205), and the garbage object information transmission module 125B starts the transmission if the monitoring module 130B has set a transmission start flag. Then, in the virtual machine 110A, the garbage object collection module 123 collects the garbage objects in the heap area 112A based on the marks received from the virtual machine 110B (S108).

The monitoring modules 130 (130A and 103B) for determining the opportunity for the start of the GC and the opportunity for the start of transmission respectively include remaining-memory-capacity monitoring modules 132 (132A and 132B), active system processing load monitoring modules 133 (133A and 133B), auxiliary system resource monitoring modules 134 (134A and 134B), and threshold management tables 131 (131A and 131B), and determine the opportunities by comparing values acquired and calculated by each of the monitoring modules, which are components, to the thresholds in the threshold management tables 131. The start opportunity determination by the monitoring module 130 enables the JavaVM 111A to carry out GC start processing and garbage object collection processing at proper time points.

In the virtual machine 110A, the monitoring module 130A is invoked when the Java program execution module 115A assigns an object in the heap area 112A, and determines the GC start condition. Alternatively, the Java program execution module 115A may call the monitoring module 130A at a predetermined time interval. In the virtual machine 110B, the monitoring module 130B is called at a predetermined interval by the garbage object information transmission module 125B of the virtual machine 110B, and determines the transmission start condition.

FIG. 3 is a diagram illustrating an example of a data format of the threshold management table 131 set respectively to the virtual machine 110A and the virtual machine 110B according to the first embodiment. The threshold management table 131 includes threshold type fields 211 and threshold fields 212. The threshold type field 211 stores a type of a threshold to be set. The threshold field 212 stores the threshold.

In the illustrated example, a remaining memory capacity threshold for the GC start conditions and a remaining memory capacity threshold for the transmission start conditions are set according to a free capacity of a storage volume of the heap area 112A assigned to the virtual machine 110A. Moreover, the remaining memory capacity decrease rate threshold for the GC start conditions and the remaining memory capacity decrease rate threshold for the transmission start conditions are set according to a decrease rate of the free capacity of the heap area 112A assigned to the virtual machine 110A. It should be noted that the decrease rate is represented by a free capacity per unit time, and is thus represented in MB/sec, for example. Moreover, an active system CPU usage rate threshold for the GC start conditions, and an active system CPU usage rate threshold for the transmission start conditions are set according to the usage rate of the CPU 181 used by the virtual machine 110A, an auxiliary system CPU usage rate threshold for the GC start conditions and an auxiliary system CPU usage rate threshold for the transmission start conditions are set according to the usage rate of the CPU 181 used by the virtual machine 110B, and an auxiliary system memory usage rate threshold for the GC start conditions and an auxiliary system memory usage rate threshold for the transmission start conditions are set according to a usage rate of the heap area 112B in the virtual machine 110B. It should be noted that the threshold management table 131B of the virtual machine 110B is a copy of the threshold management table 131A of the virtual machine 110A.

FIG. 5A is diagram illustrating an example of a data format of the non-garbage object information management table 124 according to the first embodiment, and FIG. 5B is a memory map illustrating an example in which the non-garbage object information management table 124 is applied to the heap area 112. The non-garbage object information management table 124B in the virtual machine 110B stores a result of the determination processing carried out by the garbage object determination module 122B. The non-garbage object information management table 124A of the virtual machine 110A stores the non-garbage object information received by the garbage object information reception module 126 of the virtual machine 110A from the garbage object information transmission module 125B of the virtual machine 110B.

The non-garbage object information management table 124 contains start address fields 231 and end address fields 232. The start address filed 231 stores a start address of each of non-garbage objects. The end address field 232 stores an end address of the non-garbage object.

The element number of the non-garbage object information management table 124 is variable, and the number thereof is equal to the number of the non-garbage objects in the heap area 112+1. For example, if there are three non-garbage objects of a non-garbage object 301, a non-garbage object 302, and a non-garbage object 303, in the heap area 112 as illustrated in FIG. 5B, the number of the elements of the non-garbage object information management table 124 is four, and an element E301, an element E302, and an element E303 of FIG. 5A respectively stores a start memory address and an end memory address of the non-garbage object 301, the non-garbage object 302, and the non-garbage object 303. A last element E300 stores 0 both in the start address and the end address in order to indicate the end of the non-garbage object information management table 124.

According to the first embodiment, the garbage object determination processing carried out by the garbage object determination module 122B is, as described above, the processing in which the garbage object determination module 122B searches the heap area 112B, determines objects being used as non-garbage objects based on the reference relationship among the objects, and determines storage volumes (start address and end address) in the heap area 112B of the determined non-garbage objects, and areas other than the non-garbage objects are determined as garbage.

A description is now given of Steps S101, S204, S205, and S107, which are particularly characteristic in this invention out of steps of FIG. 2, referring to the flowcharts.

A detailed description is first given of details of the processing of S101 of FIG. 2, which is the GC-start-condition determination processing, referring to the flowchart of FIG. 6.

The monitoring module 130A of the virtual machine 110A first requests the remaining-memory-capacity monitoring module 132A for the GC start condition determination (S330). The remaining-memory-capacity monitoring module 132A acquires the remaining memory capacity of the heap area 112A, and sets the GC start flag to an effective state (“1”, for example) if the remaining memory capacity is equal to or less than the threshold set to the threshold management table 131A. Moreover, the remaining-memory-capacity monitoring module 132A also calculates the decrease rate of the remaining memory capacity of the heap area 112A, and sets the GC start flag to the effective state if the decrease rate is equal to or more than the threshold set to the threshold management table 131A. Each of the thresholds is acquired by referring to the threshold management table 131A. The decrease rate is calculated using the remaining memory capacity monitoring table 135A. Specifically, each time the remaining memory capacity monitoring module 132A acquires the remaining memory capacity of the heap area 112A, the remaining-memory-capacity monitoring module 132A stores a time and the remaining capacity which are acquired at that time. The decrease rate is calculated by dividing a difference between the present remaining capacity and a previous remaining capacity by a difference between the present time and a previous time, thereby obtaining a change in remaining capacity per unit time. The remaining-memory-capacity monitoring module 132A enables the start of the GC processing before the execution of the JavaVM 111A becomes difficult due to an insufficient remaining capacity of the free memory.

The monitoring module 130A then requests the active system processing load monitoring module 133A for the GC start condition determination (S331). The active system processing load monitoring module 133A acquires the usage rate of the CPU 181 by the JavaVM 111A of the virtual machine 110A, which is the active system, from the hypervisor 170, and sets the GC start flag to the effective state (“1”, for example) if the usage rate is equal to or less than the threshold. The usage rate of the CPU 181 is acquired by the active system processing load monitoring module 133A communicating with the hypervisor 170 which manages the resource allocation of the CPU 181 to the virtual machine 110A. Each of the thresholds is acquired by referring to the threshold management table 131A. The execution of the copy generation processing of the virtual machine 110A is enabled by the active system processing load monitoring module 133A when a processing performance of the CPU 181 has a margin for the processing by the JavaVM 111A.

It should be noted that the hypervisor 170 respectively assigns virtual CPUs (or logical CPUs) to the virtual machines 110A and 110B, and returns usage rates of the virtual CPUs as the usage rates of the CPU 181. On this occasion, the usage rates of the virtual CPUs by the virtual machines 110A and 110B are used as the CPU usage rates of the Java VMs 111 for the sake of convenience. Alternatively, CPU usage rates actually used by the JavaVMs 111 may be obtained by respectively multiplying the usage rates of the virtual CPUs of the virtual machines acquired from the hypervisor 170 by CPU usage rates of the JavaVMs 111 acquired from the OSes 160A and 160B.

Finally, the monitoring module 130A of the virtual machine 110A requests the auxiliary system resource monitoring module 134A for the GC start condition determination (S332). The auxiliary system resource monitoring module 134A acquires the usage rates of the CPU 181 and the memory 182 (heap area 112B) of the virtual machine 110B, and sets the GC start flag to the effective state if the usage rate of the CPU 181 or the usage rate of the memory is equal to or less than the threshold (CPU processing system threshold for the auxiliary system or the memory usage rate threshold for the auxiliary system). Each of the usage rates of the virtual machine 110B is acquired by the auxiliary system resource monitoring module 134A communicating with the hypervisor 170 managing the CPU 181 and the memory 182. The thresholds are acquired by referring to the threshold management table 131A. The GC processing can be started by the auxiliary system resource monitoring module 134A when the computer resources required for generating the virtual machine 110B, which is the auxiliary system, have a margin. Control provided by the auxiliary system resource monitoring module 134A is particularly effective if a plurality of JavaVMs 111 are operating on the hypervisor 170, and computer resources sufficient for all the JavaVMs 111 to simultaneously generate and execute auxiliary systems are not present on the computer system 100.

The sequence of the requests in Steps S330 to S332 of FIG. 6 may be different, or a plurality of requests may be issued in parallel.

FIG. 4 is a diagram illustrating an example of a data format of the remaining memory capacity monitoring tables 135 (135A and 135B) according to the first embodiment. The remaining-memory-capacity monitoring modules 132 (132A and 132B) of the respective virtual machines 110A and 110B record the free capacities of the heap areas 112A and 112B (remaining capacities of the storage volumes) in the remaining memory capacity monitoring tables 135 (135A and 135B), and the remaining memory capacity monitoring tables 135 store values to be referred to.

The remaining memory capacity monitoring table 135 contains time fields 221 and remaining capacity fields 222. The time field 221 stores a time when the remaining-memory-capacity monitoring module 135 records the free capacity of the heap areas 112A and 112B in the remaining memory capacity monitoring table 135. The remaining capacity field 222 stores a remaining memory capacity of the heap areas 112 (112A and 112B) at the time in the time field 221.

A description is now given of the non-garbage-object-information storage processing S204 of FIG. 2. In the storage processing of the non-garbage object information, the garbage object information transmission module 125B of the virtual machine 110B sequentially routes through all objects in the heap area 112B starting from the root, and stores information on marked objects in the non-garbage object information management table 124B. A detailed description is given of this processing referring to the flowchart of FIG. 7.

The garbage object information transmission module 125B first acquires a first object in the heap area 112B, and stores information on this object in a variable x (S451).

The garbage object information transmission module 125B determines whether unprocessed objects are present in the heap area 112B in the following Step S454. If unprocessed objects exist, the garbage object information transmission module 125B proceeds to Step S460. If an unprocessed object does not exist, the garbage object information transmission module 125B finishes the processing of the flowchart of FIG. 7.

In Step S460, the garbage object information transmission module 125B checks whether the mark by the garbage object determination module 122B is present in the information on the objet stored in the variable x.

If the object in the variable x is bearing the mark set in advance in Step S461, the garbage object information transmission module 125B proceeds to Step S464. If the object does not bear the mark, the garbage object information transmission module 125B proceeds to Step S467.

In Step S464, the garbage object information transmission module 125B stores the start address and the end address of the object which is determined as a non-garbage object based on the presence/absence of the mark in the non-garbage object information management table 124B, and proceeds to Step S467.

In Step S467, the garbage object information transmission module 125B updates the value of the variable x to an object next to x in the heap area 112B, and proceeds to Step S454.

The garbage object information transmission module 125B subsequently repeats the loop from Step S454 to Step S467 until the above-mentioned processing is finished for all the objects in the heap area 112B.

A detailed description is now given of the determination-result-transmission-start-condition determination processing S205 of FIG. 2 referring to the flowchart of FIG. 8.

The monitoring module 130B of the virtual machine 110B first requests the remaining-memory-capacity monitoring module 132B for the transmission start condition determination (S350). The remaining-memory-capacity monitoring module 132B communicates with the virtual machine 110A, thereby acquiring the remaining memory capacity of the heap area 112A, and sets the transmission start flag to an effective state (“1”, for example) if the remaining capacity of the memory 182 of the virtual machine 110A is equal to or less than the threshold. Moreover, the monitoring module 130B also acquires the decrease rate of the remaining capacity of the heap area 112A from the virtual machine 110A, and sets the transmission start flag to the effective state if the decrease rate is equal to or more than the threshold. The remaining capacity and the decrease rate of the remaining capacity of the heap area 112A are acquired by the remaining-memory-capacity monitoring module 132B communicating with the remaining-memory-capacity monitoring module 132A of the virtual machine 110A. Each of the thresholds is acquired by referring to the threshold management table 131B. The remaining-memory-capacity monitoring module 132B enables the transmission of the determination result, thereby collecting the free areas of the memory by setting the transmission start flag to the effective state before the execution of the JavaVM 111A becomes difficult due to an insufficient remaining capacity of the free memory in the heap area 112A.

The monitoring module 130B then requests the active system processing load monitoring module 133B for the GC start condition determination (S351). The active system processing load monitoring module 133B acquires the usage rate of the CPU 181 by the JavaVM 111A from the virtual machine 110A, and sets the transmission start flag to the effective state (“1”, for example) if the usage rate is equal to or less than the threshold. The usage rate of the CPU 181 is acquired as the usage rate of the virtual CPU by the active system processing load monitoring module 133B communicating with the hypervisor 170 as described above. The threshold of the usage rate of the CPU 181 is acquired by the active system processing load monitoring module 133B referring to the threshold management table 131B. The reception processing of the garbage object information and the collection of the garbage objects can be enabled by the active system processing load monitoring module 133B when the processing by the JavaVM 111A has a margin in the virtual machine 110A.

The monitoring module 130B finally requests the auxiliary system resource monitoring module 134B for the GC start condition determination (S352). The auxiliary system resource monitoring module 134B acquires the usage rates of the CPU 181 and the memory 182, and sets the transmission start flag to the effective state (“1”, for example) if the usage rate is equal to or more than the threshold. The usage rates of the CPU 181 and the memory 182 are acquired by the processing system resource monitoring module 134B communicating with the hypervisor 170 in the same manner as described above. The thresholds of the usage rates of the CPU 181 and the memory 182 are acquired by referring to the threshold management table 131B.

When the computer resources required for the generation and execution of the virtual machine 110B are running short, the transmission processing can be started by the auxiliary system resource monitoring module 134B, thereby returning the CPU 181 and the memory 182 used by the virtual machine 110B to the hypervisor 170.

The sequence of the requests in Steps S350 to S352 by the monitoring module 130B may be different, or a plurality of requests may be issued in parallel as in the case of the monitoring module 130A.

A description is now given of the non-garbage object marking processing S107 of FIG. 2. The non-garbage object marking processing is carried out by the garbage object information reception module 126 sequentially routing through all objects in the heap area 112A starting from the root, and marking objects registered to the non-garbage object management table 124A. A detailed description is given of this processing referring to the flowchart of FIG. 9.

The garbage object information reception module 126A first acquires a first object in the heap area 112A, and stores information on the object into a variable x (S551).

In Step S554, the garbage object information reception module 126 determines whether unprocessed objects are present in the memory area (heap area 112A). If unprocessed objects exist, the garbage object information reception module 126 proceeds to Step S560. If an unprocessed object does not exist, the garbage object information reception module 126 finishes the processing of the flowchart of FIG. 9.

In Step S560, the garbage object information reception module 126 checks whether the object stored in the variable x is stored in the non-garbage object information management table 124A.

In Step S561, if the object stored in the variable x is stored in the non-garbage object information management table 124A, the garbage object information reception module 126 proceeds to Step S564. If the object stored in the variable x is not stored in the non-garbage object information management table 124A, the garbage object information reception module 126 proceeds to Step S567.

In Step S564, the garbage object information reception module 126 marks the object which is determined as a non-garbage object, and proceeds to Step S567.

In Step S567, the garbage object information reception module 126 updates the value of the variable x to an object next to x in the heap area 112A, and proceeds to Step S554.

The garbage object information reception module 126 subsequently repeats the loop from Step S554 to Step S567 until the above-mentioned processing is finished for all the objects in the heap area 112A.

As described above, in the computer system 100 according to the first embodiment, the virtual machine 110B (second processing system different from the first processing system), which is a copy of the virtual machine 110A, is generated in place of the virtual machine 110A (first processing system) for executing the JavaVM 111A, and the garbage object determination processing is carried out in the heap area 112B of the JavaVM 111B of the virtual machine 110B, with the result that the GC processing can be realized in a short GC stop period while the JavaVM 111A executed on the virtual machine 110A is maintained to a high throughput.

The GC processing can then be started before the execution of the JavaVM 111A becomes difficult due to an insufficient remaining capacity of the free memory by setting the opportunity (first opportunity) of the start of the GC processing to the case where the remaining memory capacity (capacity of the free space available for the JavaVM 111A) of the heap area 112A is equal to or less than the threshold, or the case where the decrease rate of the remaining memory capacity is equal to or more than the threshold.

Further, garbage objects can be determined without affecting the processing load imposed on the virtual machine 110A by carrying out the determination of the non-garbage objects in the heap area on the virtual machine 110B which is a processing system different from the virtual machine 110A executing the JavaVM 111A.

The GC processing can be executed before the execution of the JavaVM 111A becomes difficult, or at a CPU usage rate which does not affect the execution of the JavaVM 111A by setting the opportunity (second opportunity) for transmitting the determination result of the non-garbage objects from the virtual machine 110B to the virtual machine 110A to the time point when the CPU usage rate of the virtual machine 110A of the active system is equal to or less than the threshold or when the remaining memory capacity of the heap area 112A of the virtual machine 110A is equal to or less than a threshold.

### Second Embodiment

A description is now given of a second embodiment of this invention. In the second embodiment, referring to the drawings, a detailed description is given of a case where the JavaVM 111 is used as a program running on the computer system 100 and the GC processing for the JavaVM 111 is started by a notification from a processing system external to the JavaVM 111 as an opportunity.

As illustrated in FIG. 10A, according to the second embodiment, computer resources used for the garbage object determination processing are effectively shared among the JavaVMs 111 by notifying, from a program for the GC control operating on a virtual machine different from the virtual machine 110A, the JavaVM 111 on one or more virtual machines 110A running on the computer system 100 of the opportunity for starting the GC processing. The GC control program notifies a JavaVM 111, for which it is determined that the start of the GC processing is appropriate, of the opportunity for starting the GC processing. The GC control program waits without notifying a new opportunity for starting the GC processing during the garbage object determination processing for the copied virtual machine generated by the JavaVM 111 to which the opportunity for starting the GC has been notified, and restarts the notification of the opportunity for starting the GC if the GC control program receives the GC completion notification from the JavaVM to which the opportunity for starting the GC processing has been notified. Consequently, computing resources corresponding to one copied virtual machine can be efficiently shared among JavaVMs.

The processing described above can be executed by adding a virtual machine 110C as a third processing system for executing the GC control program to the configuration of the first embodiment, transmitting/receiving a GC start command between the JavaVM 111 and the GC control program in Step S101 of FIG. 2, and transmitting/receiving the GC completion notification between the JavaVM 111 and the GC control program after Step S106.

FIGS. 10A to 10C are block diagrams illustrating a configuration of the computer system according to the second embodiment. It should be noted that two or more virtual machines 110A may exist on the memory 182.

The virtual machine 110C is stored in the memory 182, and an operating system 160C and a GC control program 1191 operate on the virtual machine 110C.

The GC control program 1191 includes a CPU usage rate acquisition module 1197, a remaining memory capacity acquisition module 1198, a GC control threshold table 1196, a GC start command transmission module 1195, and a GC-processing-completion-notification reception module 1199. The CPU usage rate acquisition module 1197 is a processing module for acquiring the CPU usage rate by the JavaVM 111 on the virtual machine 110A from the hypervisor 170. The remaining memory capacity acquisition module 1198 is a processing module for acquiring the remaining memory capacity of the heap area 112 on the virtual machine 110A. The GC control threshold table 1196 is a table for storing various thresholds referred to for selecting a JavaVM 111 which is controlled to start the GC processing by the GC control program 1191. The GC start command transmission module 1195 is a processing module for transmitting the GC start command. The GC processing completion notification reception module 1199 is a processing module for receiving the GC processing completion notification.

A remaining memory capacity transmission module 1128 contained in the monitoring module 130 of the JavaVM 111 executed on the virtual machine 110A is a processing module for notifying the GC control program 1191 in the virtual machine 110C of the remaining memory capacity of the heap area 112. A GC start command reception module 1125 contained in the GC processing module 120 of the JavaVM 111 is a processing module for receiving the GC start notification by the GC control program 1191, and starting the GC processing for the heap area 112. The other configuration is the same as in the first embodiment, and a description thereof is therefore omitted. Though the virtual machine 110A executing the JavaVM 111 is illustrated in FIG. 10A, the Java VM 111 is also executed on the virtual machines (not shown).

FIG. 11 is a sequence diagram illustrating an overview of the GC processing according to this embodiment.

The GC control program 1191 first selects a JavaVM 111 which is to start the GC processing if predetermined conditions hold true (S1300).

The GC control program 1191 then transmits the GC start command to the selected JavaVM 111 (S1301). If the GC start command reception module 1125 of the virtual machine 110A executing the JavaVM 111 receives the GC start command (S1101), the GC start command reception module 1124 instructs the virtual machine copying module 171 of the hypervisor 170 to start the GC processing of generating a copy of the virtual machine 110A as the virtual machine 110B as in the first embodiment (S102). Subsequently, the processing in S109, S102, S110, S103, and S106 in the virtual machine 110A, and the processing in S110, S203, S204, S205, and S206 in the virtual machine 110B are the same as the processing in the first embodiment. The GC control program 1191 waits during this processing (S1302).

The GC processing completion notification transmission module 1126 of the JavaVM 111 transmits the GC processing completion notification to the GC control program 1191 after Step S106 (S1107). If the GC processing completion notification reception module 1199 receives the GC processing completion notification, the GC controls program 1191 returns again to the determination processing in S1300. Moreover, Steps S107 and S108 executed by the JavaVM 111 after Step S1107 are the same as the processing in the first embodiment.

A detailed description is now given of points in which the second embodiment is different from the first embodiment.

FIG. 12 is a diagram illustrating an example of a data format of the GC control threshold table 1196 according to the second embodiment. The GC control threshold table 1196 stores various thresholds referred to by the GC start command transmission module 1195. The GC control threshold table 1196 contains threshold type fields 1211 and threshold fields 1212 as in the threshold management table 131 of the first embodiment.

A description is now given of Step S1300, which is characteristic particularly in the second embodiment, out of steps of FIG. 11 referring to the flowchart of FIG. 13.

In the GC start determination processing S1300, the GC control program 1191 transmits the GC start command to a JavaVM 111 having the smallest remaining memory capacity out of JavaVMs 111 having a CPU usage rate and a remaining memory capacity of the JavaVM 111 both of which are less than the thresholds in the virtual machine 110A and in virtual machines (not shown). It should be noted that each of the thresholds are values set in advance to the GC control threshold table 1196. The condition that the CPU usage rate is equal to or less than the threshold is set in order to select a JavaVM 111 which has a margin for starting the GC processing. Moreover, the condition that the remaining memory capacity is equal to or less than the threshold is set for selecting a JavaVM 111 for which the necessity for executing the GC processing is high. In particular, the condition that the remaining memory capacity is the smallest enables the JavaVM 111 for which the necessity for the GC processing is high to start the GC processing.

The GC control program 1191 first acquires respectively the CPU usage rate and the remaining memory capacity of the plurality of JavaVMs 111. The CPU usage rate is acquired by the CPU usage rage acquisition module 1197 communicating with the hypervisor 170 as in the first embodiment (S1501). The remaining memory capacity is acquired by the remaining memory capacity acquisition module 1198 communicating with the remaining memory capacity transmission module 1128 of the JavaVM 111 (S1502).

The GC control program 1191 then determines whether JavaVMs having both a CPU usage and a remaining memory capacity equal to or less than the thresholds are present. The various thresholds are obtained by referring to the GC control threshold table 1196 (S1503, S1505). If there is not a JavaVM 111 satisfying the condition of each of the thresholds, the GC control program 1191 waits for a certain period set in advance by the administrator or the like (S1506), returns to Step S1501 again, and then repeats the processing.

If there are JavaVMs 111 having both a CPU usage rate and a remaining memory capacity equal to or less than the thresholds, the GC control program 1191 selects a JavaVM 111 having the smallest remaining memory capacity out of the JavaVMs 111 satisfying the conditions as the JavaVM to which the GC processing start notification is to be transmitted (S1507).

As described above, in the computer system 100 according to the second embodiment, the computing resources used for the garbage object determination processing can be efficiently shared among the JavaVMs 111 by the GC control program 1191 controlling the GC processing for one or more JavaVMs 111.

### Third Embodiment

Referring to the drawings, a detailed description is now given of an embodiment, as a third embodiment of this invention, where the JavaVM 111 is used as a program running on the computer system 100, the GC processing for the JavaVM 111 is started based on an opportunity detected by the monitoring inside the JavaVM 111, and garbage objects are collected per memory page as a unit during the collection processing. It should be noted that, according to the third embodiment, the JavaVM 111 (or OS 160) manages the heap area 112 per page which is a predetermined storage volume (some kilobytes, for example).

Both the garbage object determination processing and the garbage object collection processing can be executed in a short stop period while a high throughput is maintained by combining the improvement in the garbage object collection processing according to the collection method per memory page and the improvement in the garbage object determination processing according to this invention, which is effective. However, according to a conventional method, if the garbage object collection is carried out per memory page, and even a small number of non-garbage objects are present in a page, the entire page is not to be collected, and there poses a problem that the usage efficiency of the memory degrades. The third embodiment employs the collection method per memory page for the garbage object collection processing, and processing of controlling the non-garbage objects to migrate from a page in which only a small number of non-garbage objects exist is further added, thereby increasing the quantity of the garbage pages, and solving the problem regarding the memory usage efficiency.

FIGS. 14A and 14B are explanatory diagrams illustrating an example of the effect of improving the memory usage efficiency by collection-subject-area increasing processing according to the third embodiment.

The heap area (memory area) 112 includes a memory page 2210, a memory page 2220, and a memory page 2230. The memory page 2220 is a page which does not contain a non-garbage object within the area. The memory page 2210 is a page which contains a non-garbage object 2200 within the area. The memory page 2230 is a page which contains a garbage object area larger than the non-garbage object 2200 within the area. If the collection-subject-area increasing processing is not carried out, while the memory page 2220 is subject to the collection, the non-garbage object is present in the memory page 2210, and the memory page 2210 is thus not subject to the collection.

The collection-subject-area increasing processing controls the non-garbage object 2200 to migrate to the garbage object area in the memory page 2230. As a result, the memory page 2210 no longer contains a non-garbage object. Thus, the memory page 2210 also becomes subject to the collection, and continuity of the free area in the memory (heap area 112) thus increases, thereby increasing the usage efficiency.

FIG. 15 is a sequence diagram illustrating an overview of the GC processing according to the third embodiment. According to the third embodiment, the increase in the memory usage efficiency is realized by carrying out the collection-subject-area increasing processing (S2108) after the non-garbage object marking processing (S107) out of the processing steps of the first embodiment illustrated in FIG. 2, and then carrying out the garbage object collection processing (S108). The other processing is the same as that of the first embodiment illustrated in FIG. 2.

FIGS. 16A and 16B are block diagrams illustrating a configuration of the computer system according to the third embodiment. The computer system according to the third embodiment includes a collection subject area increasing processing module 2131, a collection subject area threshold management table 2132, and an object migration destination management table 2133 in the GC processing module 120 in addition to the components according to the first embodiment.

The collection subject area increasing processing module 2131 is a processing module for controlling non-garbage objects to migrate from pages where the capacity of garbage objects is equal to or more than a threshold, thereby increasing the number of garbage pages. The collection subject area threshold management table 2132 is a table storing the threshold referred to by the collection subject area increasing processing module 2131. This threshold is set in advance by the administrator or the like. The object migration destination management table 2133 is a table storing addresses of a migration source and a migration destination of non-garbage objects controlled to migrate by the collection subject area increasing processing module 2131. The other configuration is the same as that of the first embodiment.

A detailed description is now given of a difference between the third embodiment and the first embodiment.

FIG. 17 is a diagram illustrating an example of a data format of the collection subject area threshold management table 2132 according to the third embodiment. The collection subject area threshold management table 2132 contains threshold type fields 2211 and threshold fields 2212 as in the threshold management table 131.

FIG. 18 is a diagram illustrating an example of a data format of the object migration destination management table 2133 according to the third embodiment. The object migration destination management table 2133 contains migration source address fields 2311 and migration destination address fields 2312. The migration source address field 2311 stores an address of a migration source of an object controlled to migrate by the collection subject area increasing processing module 2131. The migration destination address filed 2312 stores an address of a migration destination of the object. Both the migration source address and the migration destination address of a last element E2300 of the object migration destination management table 2133 are set to zero to indicate the end of the object migration destination management table 2133.

A detailed description is now given of the collection subject area increasing processing S2108 of FIG. 15 referring to the flowchart of FIG. 19.

The collection subject area increasing processing module 2131 first calculates the maximum value of the number of garbage pages which can exist in the heap area 112 after the non-garbage object migration processing. This maximum value is obtained by dividing the total capacity of the garbage objects contained in the heap area 112 by the total number of the memory pages in the heap area 112. On this occasion, the fraction is truncated. The collection subject area increasing processing module 2131 stores the maximum value to a variable n (S2205).

The collection subject area increasing processing module 2131 then initializes a variable m indicating the number of garbage pages to the number of the garbage pages in the heap area 112 (S2207).

In subsequent processing, the collection subject area increasing processing module 2131 carries out migration processing for non-garbage objects on non-garbage pages containing garbage objects equal to or more than a threshold out of the memory pages in the heap area 112. The migration processing is repeated until the number of the garbage pages cannot increase any more, or there is no non-garbage page containing garbage objects equal to or more than the threshold.

First, the collection subject area increasing processing module 2131 compares the values of variables n and m with each other. The variable m denotes the number of pages of the garbage pages, and the variable n denotes the maximum number of garbage pages which can exist after the migration processing, and hence if the variable m and the variable n are equal to each other, the number of the garbage pages can no longer increase. Therefore, if the variable m and the variable n are equal to each other, the collection subject area increasing processing module 2131 finishes the processing illustrated in the flowchart of FIG. 19 (S2215).

If the number of the garbage pages can increase, the collection subject area increasing processing module 2131 determines whether non-garbage pages containing garbage objects equal to or more than the threshold are present. In this case, the collection subject area increasing processing module 2131 first confirms whether non-garbage pages are present, and if there is no non-garbage page, the collection subject area increasing processing module 2131 finishes the processing illustrated in the flowchart of FIG. 19 (S2216). If non-garbage pages are present, a non-garbage page having the largest capacity of garbage objects contained in the memory page is obtained and is stored in a variable p (S2217), and it is determined whether the garbage object capacity is larger than the collection subject area increasing processing threshold. The collection subject area increasing processing threshold is acquired by referring to the collection subject area threshold management table 2132. If the garbage object capacity of the variable p is smaller than the threshold, there is no non-garbage page containing garbage objects equal to or more than the threshold in the heap area 112, and hence the collection subject area increasing processing module 2131 finishes the processing illustrated in the flowchart of FIG. 19 (S2218).

The collection subject area increasing processing module 2131 then controls non-garbage objects in the variable p to migrate to another memory page. The garbage object capacity decreases in the migration destination page, and the possibility that the page becomes subject to the collection subject area increasing processing decreases. Therefore, the collection subject area increasing processing module 2131 controls the non-garbage objects to migrate to a page having the smallest capacity of garbage objects, which is originally less likely to become a subject, out of the pages which may be migration destination pages.

First, the collection subject area increasing processing module 2131 acquires a non-garbage page having the smallest total capacity of garbage objects contained in the page, stores the page in a variable q (S2222), and controls as many non-garbage objects in the page stored in the variable p as possible to migrate to the page stored in the variable q (S2223). When an object is controlled to move, the collection subject area increasing processing module 2131 stores an address of the object to be migrated before the migration and an address of the object to be migrated after the migration in the object migration destination management table 2133. If non-garbage objects are left in the page stored in the variable p after the migration, the collection subject area increasing processing module 2131 returns to Step S2222 (S2225), and repeats again the migration processing to a page having the smallest total capacity of garbage objects. Subsequently, the migration processing is repeated until the variable p becomes a garbage page. The comparison result between the variable n and the variable m in Step S2215 ensures that non-garbage objects in the page stored in the variable p can be controlled to migrate to pages other than the variable p, and this algorithm thus stops.

The collection subject area increasing processing module 2131 then rewrites references to the addresses before the migration to the non-garbage objects controlled to migrate from the page stored in the variable p in the heap area 112 to the new addresses after the migration (S2226).

Finally, the collection subject area increasing processing module 2131 increments the variable m representing the number of the garbage pages by one (S2227), and finishes the migration processing for the variable p. The collection subject area increasing processing module 2131 then returns to S2215, and repeats the migration processing for a new page.

As described above, according to the third embodiment, the garbage object determination processing and the garbage object collection processing which simultaneously realize a high throughput and a short stop period while restraining degradation of the memory usage efficiency can be carried out.

### Fourth Embodiment

Referring to the drawings, a detailed description is now given of, as a fourth embodiment of this invention, an embodiment where the JavaVMs 111 (111A and 111B) are used as programs running on the computer system 100, and an auxiliary process (auxiliary system) is used as an auxiliary processing system for carrying out the garbage object processing.

According to the fourth embodiment, a process copying function provided by the operating system is used in place of the virtual machine copying function provided by the hypervisor 170, and the garbage object determination processing is carried out by a generated copy process. It should be noted, according to the fourth embodiment, as in the first embodiment, that the GC processing for the JavaVM 111 is started based on an opportunity detected by the monitoring inside the JavaVM 111. It should be noted that the GC processing for the JavaVM 111 may be started based on an opportunity of a notification from the outside of the JavaVM 111 as in the second embodiment.

FIG. 20 is a configuration block diagram of the computer system according to the fourth embodiment. The JavaVMs 111 (111A and 111B) and the operating system 160 are stored in the memory 182. Unique process identifiers 3118 (3118A and 3118B) are set to the JavaVMs 111 by the operating system 160.

The operating system 160 includes a process copying module 3161. The process copying module 3161 is a processing module for generating a copy of a process managed by the operating system 160. A copy of the JavaVM 111A (active system=first processing system) is generated as a process 111B (second processing system different from the first processing system) by the process copying module 3161 as in the copying processing by the virtual machine copying module 171 according to the first embodiment, and then the operating system 160 sets the process identifier 3118B in the process 111B, which is the copy destination, to a value different from the process identifier 3118A of the process of the copy source. The generated copy process contains exactly the same components as the process of the copy source other than the process identifiers 3118A and 3118B, and each of the copied components starts operation in a state exactly the same as the component of the corresponding copy source at a time point when the copy is carried out.

The copied JavaVM 111B is a process generated by the process copying module 3161 copying the JavaVM 111A during the GC processing of the JavaVM 111A.

It should be noted that two or more JavaVMs 111A may exist on the memory 182. Moreover, in the computer system 100, the OS 160A generates (or secures) an area for executing the JavaVM 111A as the first processing system in the memory 182 in response to an instruction by the administrator or the user, thereby executing the JavaVM 111A.

FIG. 21 is a sequence diagram illustrating an overview of the GC processing according to the fourth embodiment. According to the fourth embodiment, generation of the JavaVM 111B in S3102 is carried out in place of the generation of the virtual machine 110B in S102 out of the processing steps according to the first embodiment. Moreover, confirmation of the process identifier in S3109 and reconfirmation of the process identifier in S3110 are carried out in place of the confirmation of the virtual machine identifier in S109 and the reconfirmation of the virtual machine identifier in S110 out of the processing steps according to the first embodiment.

The GC processing start module 121 requests the process copying module 3161 for copying the JavaVM 111A, thereby generating the newly copied JavaVM 111B in the generation of the JavaVM 111B in S3102.

The GC processing start module 121 confirms the value of the process identifier 3118A in the confirmation of the process identifier in S3109. Moreover, in the reconfirmation of the process identifier in S3110, each of the GC processing start modules 121 determines on which JavaVM 111 the GC processing start module 121 is running by comparing the process identifier 3118A confirmed in the confirmation of the process identifier in S3109 and the value of the each of the process identifiers 3118.

The other processing is the same as in the case of the first embodiment.

As a result, in the computer system 100 according to the fourth embodiment, the GC processing can be carried out while a high throughput and a short GC stop period are simultaneously provided on the Java VM 111A by using the copying function of the operating system.

Moreover, in the first to fourth embodiments, the case where the first processing system executing the JavaVM 111A and the second processing system containing the JavaVM 111B, which is a copy of the JavaVM 111A and carries out the GC processing, are executed on the one computer 100 is described. However, though illustration is omitted, a computer system may be constructed by a plurality of computers, the second processing system may be generated and the GC processing may be carried out on another computer, and the determination result of the unnecessary area may be notified to the first processing system via a network.

The following is a representative aspect of this invention other than aspects described in the scope of claims.

There is provided a device, including: a processing module for starting unnecessary memory area collection processing; a processing module for carrying out unnecessary memory area determination processing; a processing module for carrying out the unnecessary memory area collection processing; a processing module for transmitting unnecessary memory area information; a processing module for receiving the unnecessary memory area information; a processing module for copying a memory area to an auxiliary system; a processing module for monitoring a remaining memory capacity in the memory area; a processing module for monitoring a usage rate of a calculation device by a program; a processing module for monitoring a usage rate of the calculation device or a memory required for executing the auxiliary system; and a processing module for receiving an unnecessary memory area determination start instruction, in which: the processing module for monitoring the remaining memory capacity in the memory area, the processing module for receiving the unnecessary memory area determination start instruction, the processing module for monitoring the usage rate of the calculation device by the program, and the processing module for monitoring the usage rate of the calculation device or the memory required for executing the auxiliary system notify the processing module for starting the unnecessary memory area collection processing of an opportunity for starting the unnecessary memory area collection processing; when the processing module for starting the unnecessary memory area collection processing receives the notification, the processing module for starting the unnecessary memory area collection processing requests the processing module for copying the memory area in the auxiliary system for generating a copy of the memory area in the auxiliary system; when the copy of the memory area is generated, the processing module for carrying out the unnecessary memory area determination processing determines a copied unnecessary memory area in the memory area; the processing module for monitoring the remaining memory capacity, the processing module for monitoring the usage rate of the calculation device by the program, and the processing module for monitoring the usage rate of the calculation device or the memory required for executing the auxiliary system notify the processing module for unnecessary memory area information transmission of an opportunity for starting transmission processing of a determination result; when the processing module for unnecessary memory area information transmission receives the notification, the processing module for unnecessary memory area information transmission transmits the determination result to the processing module for unnecessary memory area information reception; when the processing module for unnecessary memory area information reception receives the determination result, the processing module for unnecessary memory area information reception notifies the processing module for unnecessary memory area collection of the determination result; and the processing module for unnecessary memory area collection collects an unnecessary memory area in the memory area based on the notification.

### INDUSTRIAL APPLICABILITY

As described above, this invention can be applied to a computer system and a program for carrying out the GC in a memory area, and is particularly preferred for the GC in the heap area in a computer system executing JavaVMs.

What is claimed is:

1. A memory management method, which is used in a computer including a calculation device and a memory to unload an area no longer necessary out of a memory area used by a program stored in the memory and executed by the calculation device, comprising:
generating, by the calculation device, a first processing system for executing the program in the memory;
generating, by the calculation device, a second processing system in the memory when a first opportunity occurs;
copying, by the calculation device, a content of a memory area of the first processing system to a memory area of the second processing system;
determining, by the calculation device, an unnecessary area out of the copied memory area of the second processing system;
transmitting, by the calculation device, a determination result regarding the unnecessary area to the program of the first processing system when a second opportunity occurs;
receiving, by the calculation device, the determination result in the first processing system; and
unloading, by the calculation device, the unnecessary area in the memory area of the first processing system based on the determination result regarding the unnecessary area received in the first processing system.

2. The memory management method according to claim 1, wherein the second processing system generated by the generating of the second processing system in the memory, and the copying of the content of the memory area of the first processing system to the memory area of the second processing system is generated on a computer different from the first processing system.

3. The memory management method according to claim 1, wherein the calculation device generates the second processing system as a process different from the first processing system in the memory when the first opportunity occurs.

4. The memory management method according to claim 1, further comprising measuring, by the calculation device, a remaining capacity of the memory area used by the program of the first processing system,
wherein the first opportunity occurs when the remaining capacity of the memory area used by the first processing system and a predetermined first threshold are compared with each other, and it is determined that the remaining capacity of the memory area is smaller.

5. The memory management method according to claim 1, further comprising measuring, by the calculation device, a decrease rate of a remaining capacity of the memory area used by the program of the first processing system,
wherein the first opportunity occurs when the decrease rate of the remaining capacity of the memory area used by the first processing system and a predetermined second threshold are compared with each other, and it is determined that the decrease rate of the remaining capacity of the memory area is larger.

6. The memory management method according to claim 1, further comprising measuring, by the calculation device, a usage rate of the calculation device executing the program in the first processing system,
wherein the first opportunity occurs when the usage rate of the calculation device executing the program in the first processing system and a predetermined third threshold are compared with each other, and it is determined that the usage rate of the calculation device is smaller.

7. The memory management method according to claim 1, further comprising:
measuring, by the calculation device, a remaining capacity of the memory area used by the second processing system; and
measuring, by the calculation device, a usage rate of the calculation device used by the second processing system,
wherein the first opportunity occurs when the remaining capacity of the memory area used in the second processing system and a predetermined fourth threshold are compared with each other, and it is determined that the memory area used in the second processing system is smaller, or when the usage rate of the calculation device and a predetermined fifth threshold are compared with each other, and it is determined that the usage rate of the calculation device is smaller.

8. The memory management method according to claim 1, wherein:
the generating of the first processing system for executing the program in the memory includes generating a third processing system for monitoring the first processing system, and notifying, by the third processing system, the first processing system of a result of the monitoring of the first processing system; and
the first opportunity occurs when the first processing system receives the notification from the third processing system.

9. The memory management method according to claim 1, wherein the second opportunity occurs when the determination of the unnecessary area of the memory area is finished in the second processing system.

10. The memory management method according to claim 1, further comprising measuring, by the calculation device, a decrease rate of a remaining capacity of the memory area used by the first processing system,
wherein the second opportunity occurs when the remaining capacity of the memory area used by the first processing system and a predetermined first threshold are compared with each other, and it is determined that the remaining capacity of the memory area is smaller.

11. The memory management method according to claim 1, further comprising measuring, by the calculation device, a usage rate of the calculation device executing the program in the first processing system,
wherein the first opportunity occurs when the usage rate of the calculation device executing the program in the first processing system and a predetermined third threshold are compared with each other, and it is determined that the usage rate of the calculation device is smaller.

12. The memory management method according to claim 1, further comprising:
measuring, by the calculation device, a remaining capacity of the memory area used by the second processing system; and
measuring, by the calculation device, a usage rate of the calculation device used by the second processing system,
wherein the second opportunity occurs when the remaining capacity of the memory area used in the second processing system and a predetermined fourth threshold are compared with each other, and it is determined that the memory area used in the second processing system is smaller, or when the usage rate of the calculation device and a predetermined fifth threshold are compared with each other, and it is determined that the usage rate of the calculation device is smaller.

13. A computer system, which includes a calculation device and a memory to execute a program and unload an area no longer necessary out of a memory area used by the program, comprising:
a first processing system set to the memory for executing the program;
a collection processing starting unit for generating a second processing system in the memory when a first opportunity occurs;
a copying unit for copying a content of a memory area of the first processing system to a memory area of the second processing system;
a determination unit for determining an unnecessary area out of the copied memory area of the second processing system;
a determination result transmission unit for transmitting a determination result regarding the unnecessary area to the first processing system when a second opportunity occurs; and
a collection processing execution unit for receiving the determination result in the first processing system, and unloading the unnecessary area in the memory area of the first processing system based on the received determination result regarding the unnecessary area.

14. A storage medium having a program stored thereon, the program controlling a computer, including a memory for storing a program, and a calculation device for executing the program stored in the memory, to perform the procedures of:
generating a first processing system for executing the program in the memory;
generating a second processing system in the memory when a first opportunity occurs;
copying a content of a memory area of the first processing system to a memory area of the second processing system;
determining an unnecessary area out of the copied memory area of the second processing system;
transmitting a determination result regarding the unnecessary area to the program of the first processing system when a second opportunity occurs;
receiving the determination result in the first processing system; and
unloading the unnecessary area in the memory area of the first processing system based on the determination result regarding the unnecessary area received in the first processing system.
